(19) United States
(12) Patent Application Publication
(10) Pub. No.: US 2026/0298206 A1
(43) Pub. Date: Oct. 1, 2026

(54) WIND TURBINE BLADE SPECIMEN TESTING

(71) Applicant: Vestas Wind Systems A/S, Aarhus N. (DK)

(72) Inventors: Katherine Penn, Shorwell (GB); Alistair Tillman, Ryde (GB); James Smith, Ryde (GB); Drake Lewis Marks, Ryde (GB); Thomas S. Bjertrup Nielsen, Skødstrup (DK); Peter Bøttcher, Egå (DK); Mohammed Fajar, Hinnerup (DK); Hans Buus, Aarhus N (DK); Torben Juul Larsen, Roskilde (DK)

(73) Assignee: Vestas Wind Systems A/S, Aarhus N. (DK)

(21) Appl. No.: 19/479,391

(22) PCT Filed: Apr. 26, 2024
(86) PCT No.: PCT/EP2024/061651

§ 371 Date: Oct. 28, 2025

(30) Foreign Application Priority Data
Apr. 28, 2023 (DK) PA202370212

(51) Int. Cl. F03D 17/00; G01M 5/00

(52) U.S. Cl. CPC F03D 17/011; F03D 17/028; G01M 5/0016; G01M 5/0058; F05D 2260/83

(57) ABSTRACT

Apparatus and methods for testing a wind turbine blade specimen. The wind turbine blade specimen may be the whole or a portion of a segmented wind turbine blade. The segmented wind turbine blade may be for a cable stayed rotor. The blade specimen is held at one end and an actuator applies a load on the wind turbine blade specimen. The blade specimen may have a cable connection point. A loads assembly may have at least one cable for coupling to the cable connection point. The cable is configured to carry tensile load such that the load imparted to the wind turbine blade specimen by the actuator is partially supported by the cable.

### FIELD OF THE INVENTION

The present invention relates to apparatus and methods for testing a wind turbine blade specimen.

### BACKGROUND OF THE INVENTION

Wind turbine blades are subject to various loads. The loads typically include aerodynamic forces generated by the wind, including air pressure on the blades, changing wind speed and direction, as well as loads originating from the dead weight of the blade itself.

There is a continued drive to produce larger wind turbine blades, due to the increased energy production that is produced. Yet, as the size of wind turbine blades continues to increase, the loads on the wind turbine blades also continue to increase. The increased loads often require further reinforcement of the blades, however this reinforcement further increases the weight of the blades, with a subsequent further increase in the loads acting on the blades.

WO 2022/128040 teaches a pitch controlled wind turbine comprising a tower, a nacelle mounted on the tower, a hub mounted rotatably on the nacelle, and at least three wind turbine blades connected to the hub via pitch mechanisms. The wind turbine further comprises at least three blade connecting members, each blade connecting member extending between a connection point on one wind turbine blade and a connection point on a neighbouring wind turbine blade. Pre-tension members coupled between each blade connecting member and the hub apply a tensile load in the blade connecting members which enables the wind turbine blades to mutually support each other, in the sense that loads on the wind turbine blades, in particular edgewise loads and flapwise (also known as flatwise) loads, are ‘shared’ among the wind turbine blades. This relieves loads on the blade structure inboard of the connection point, meaning that the blade structure inboard of the connection point can be designed for lower loads. The blade root diameter or reinforcement of the inboard blade portion can be reduced, achieving weight savings. This may also enable a smaller hub, smaller tower loads etc. achieving yet further weight savings for a given rotor diameter. Additionally or alternatively the rotor diameter may be increased without increasing the weight of the blades.

For certification, wind turbine blades are typically tested for static and fatigue loads to ensure the blade structure performs as intended. In a static blade test the blade is subjected to loading at a level and distribution which is determined in order to achieve a predetermined bending moment, obtained usually through simulation, having regard to the worst case conditions the blade is expected to endure. This may vary according to location of intended use of the blade (typically characterised by wind class and turbulence level).

In a fatigue test a simulation of accumulated damage level over design life is made, and loading is set such that a test of e.g. 1 million cycles will produce this accumulated damage level.

Other load levels may however be set depending on test objectives, for example there may be occasions where higher loading is applied, to test a design to destruction, or to test where specific strength issues might arise with a particular design or design feature.

As the length of wind turbine blades increases, testing of these blades becomes increasingly difficult and costly. Longer blades pose physical constraints in terms of the size of the building required to accommodate these long blades to perform the structural testing. Longer blades are typically heavier, so the loads on the test rig also increase with the blade length, posing problems in terms of ground fixings for both the blade and the test rig which applies static load to the blade. In fatigue testing the blade is typically oscillated at its natural frequency but this frequency increases with the blade length. Fatigue testing may require in excess of 1 million cycles, resulting in testing regimes for longer blades that can take many months or even years to complete.

The cost and time to test these longer blades is becoming prohibitive and delaying market entry. Furthermore, the load sharing offered by wind turbine rotors having pre-tensioned blade connecting members introduces further complexity as current testing apparatus and methods do not accommodate this load sharing between blades and the blades are typically tested individually and not as an entire rotor. There is therefore a need for improved apparatus and methods for testing blades.

### SUMMARY OF THE INVENTION

A first aspect of the invention provides an apparatus for testing a wind turbine blade specimen having a cable connection point, the apparatus comprising:
a first support for holding a first end of the wind turbine blade specimen,
a first actuator for applying a first load at a first location on the wind turbine blade specimen away from the first end,
a load assembly including at least one cable for coupling to the cable connection point at a second location on the wind turbine blade specimen away from the first end, wherein the at least one cable is configured to carry tensile load such that the load imparted to the wind turbine blade specimen by the first actuator is partially supported by the at least one cable.

More particularly, the first load as applied in the forward flatwise and in the edgewise directions is partially supported by the load assembly, thereby replicating the load relief afforded to the operational wind turbine blades by the cables in a cable-supported rotor.

The load assembly may include a plurality of cables, preferably wherein the plurality of cables are for coupling to the same cable connection point on the wind turbine blade specimen. In a preferred arrangement the load assembly comprises two cables, thereby replicating the arrangement in an operational rotor where each blade has a pair of cables which extend directly or indirectly towards the other two blades so that the loads can be shared, as discussed above.

In an alternative arrangement the load assembly comprises only a single cable.

The apparatus may further comprise a wind turbine blade specimen having a cable connection point, wherein the first support holds a first end of the wind turbine blade specimen, and the or each cable is coupled to the cable connection point at a second location on the wind turbine blade specimen away from the first end.

The wind turbine blade specimen may be an entire wind turbine blade having a root and a tip and a span extending form the root to the tip, wherein the span substantially corresponds to span of an operational wind turbine blade having substantially the same structure as the wind turbine blade specimen.

The wind turbine blade specimen may be a segmented wind turbine blade having an inboard blade portion and an outboard blade portion connected to each other at a split position, wherein the inboard blade portion and outboard blade portion are connected by a connection joint, and wherein the connection joint includes a connector connected to an end surface of the inboard blade portion and to an end surface of the outboard blade portion, and wherein the cable connection point is on the connector.

The split position may be located between 10% and 60% of the span of the whole of the segmented wind turbine blade. The whole span is between the root end and the tip end of the entire blade. The split position may be radially inboard of 50% of the span, or radially inboard of 45% of the span, preferably around 35-40% of the span.

The connector may be connected to the end surface of the inboard blade portion and to the end surface of the outboard blade portion by fasteners.

The wind turbine blade specimen may be a portion of a segmented wind turbine blade.

Testing of a blade specimen comprising only a portion, e.g. an inboard or outboard portion, of a segmented wind turbine blade has advantages over testing a blade specimen comprising the entire segmented wind turbine blade. As the first natural frequencies, flapwise and edgewise, of respectively the inner and outer blade portions are significantly higher than for the entire blade, the dynamic testing of each blade portion will be much faster than when testing the entire blade with the two blade portions connected. This may result in a shorter time to market of the wind turbine blade and faster testing results. Further a smaller test hall may be needed both in length and height, due to less blade deflection, which may reduce costs as well.

The portion is an inboard blade portion of the segmented wind turbine blade and having substantially the same structure as an operational segmented wind turbine blade.

The wind turbine blade specimen may comprise an inboard blade portion of a segmented wind turbine blade and a connector connected to an end surface of the inboard blade portion, and wherein the cable connection point is on the connector, wherein the connector is for connecting the end surface of the inboard blade portion to an end surface of an outboard blade portion to connect the inboard blade portion and the outboard blade portion to each other at a split position of the segmented wind turbine blade having substantially the same structure as an operational segmented wind turbine blade.

The wind turbine blade specimen may further comprise an extension member connected to the connector and extending away from the inboard blade portion, preferably wherein the cable connection point is on the extension member.

The cable connection point may be located a distance from a neutral axis of the wind turbine blade specimen.

The cable connection point may be located a distance from the neutral axis of the wind turbine blade specimen in the blade chordwise direction and/or a distance from the neutral axis of the wind turbine blade specimen in the blade thickness direction.

The cable may extend from the cable connection point at an angle with respect to a neutral axis of the wind turbine blade specimen, wherein the angle is an acute angle, preferably less than 45 degrees, preferably less than 30 degrees, preferably less than 25 degrees.

The cable may extend from the cable connection point at a first angle with respect to the neutral axis of the wind turbine blade specimen when viewing the wind turbine blade specimen along the blade chordwise direction and/or at a second angle with respect to the neutral axis of the wind turbine blade specimen when viewing the wind turbine blade specimen along the blade thickness direction.

The magnitude of the first angle may be less than the magnitude of the second angle.

The load assembly may include a pair of cables coupled to the same cable connection point on the wind turbine blade specimen, and wherein the first angles of the respective cables of the pair of cables are substantially identical and extend to the same side of the blade neutral axis when viewing along the blade chordwise direction, and wherein the second angles of the respective cables of the pair of cables are either similar or dissimilar and extend to opposite sides of the blade neutral axis when viewing along the blade thickness direction.

The cable may extend from the cable connection point substantially perpendicular to a neutral axis of the wind turbine blade specimen.

The load assembly may be configured to apply a tensile load in the cable which varies with displacement of the cable.

The load assembly may be configured to apply a predetermined tensile load in the cable.

The load assembly may further comprise at least one cable actuator coupled to the at least one cable for applying a tensile load in the cable. The cable actuator may be a hydraulic actuator.

The cable actuator may be actively or passively controllable.

The at least one cable may be a first cable, and the load assembly may further comprise at least one second cable, wherein an end of one first cable and an end of one second cable are connected to a first end of the cable actuator, and wherein the other end of the second cable is coupled to a first fixation point, and wherein a second end of the cable actuator is coupled to a second fixation point.

The first and second ends of the cable actuator may have freedom of movement.

The second end of the cable actuator may be coupled to the second fixation point by an adjustable connection.

The first and second fixation points may each be substantially rigidly fixed with respect to the first support.

The load assembly may further comprise a cam mounted to a rotatable shaft, wherein the cam is connected to one end of the at least one cable, and the shaft may be coupled to a mass to form a pendulum arrangement to react load in the cable.

The load assembly may further comprise an elastic element, wherein a first end of the elastic element is connected to one end of the at least one cable, a second end of the elastic element is substantially rigidly fixed with respect to the first support, and the elastic element is deformable to react load in the cable.

The load assembly may further comprise a spring or ram actuator, wherein a first end of the spring or ram actuator is connected to one end of the at least one cable, and a second end of the spring or ram actuator is connected to a third fixation point, and the spring or ram actuator is extensible to react load in the cable.

The load assembly may further comprise a pulley and the at least one cable runs over the pulley.

The third fixation point may be mounted to the first support, the third fixation point being on an opposite side of the first support to the side from which the wind turbine blade specimen is mounted.

The ram actuator may be actively or passively controllable.

A further aspect of the invention provides a method of testing a wind turbine blade specimen comprising:
providing a wind turbine blade specimen having a having a cable connection point;
supporting a first end of the wind turbine blade specimen;
connecting at least one cable to the cable connection point at a second location on the wind turbine blade specimen away from the first end;
tensioning the at least one cable;
using a first actuator to apply a first load at a first location on the wind turbine blade specimen away from the first end;
using the cable to carry tensile load such that the load imparted to the wind turbine blade specimen by the first actuator is partially supported by the cable; and
measuring one or more parameters of the wind turbine blade specimen.

The wind turbine blade specimen may be an entire wind turbine blade and having a root and a tip and a span extending form the root to the tip, wherein the span substantially corresponds to span of an operational wind turbine blade having substantially the same structure as the wind turbine blade specimen.

The wind turbine blade specimen may be a segmented wind turbine blade having an inboard blade portion and an outboard blade portion connected to each other at a split position, wherein the inboard blade portion and outboard blade portion are connected by a connection joint, and wherein the connection joint includes a connector connected to an end surface of the inboard blade portion and to an end surface of the outboard blade portion, and wherein the cable connection point is on the connector.

The split position may be located between 10% and 60% of the span of the whole of the segmented wind turbine blade. The whole span is between the root end and the tip end of the entire blade. The split position may be radially inboard of 50% of the span, or radially inboard of 45% of the span, preferably around 35-40% of the span.

The connector may be connected to the end surface of the inboard blade portion and to the end surface of the outboard blade portion by fasteners.

The wind turbine blade specimen may be a portion of a segmented wind turbine blade, preferably wherein the portion is an inboard blade portion of the segmented wind turbine blade and having substantially the same structure as an operational segmented wind turbine blade.

The wind turbine blade specimen may comprise an inboard blade portion of a segmented wind turbine blade and a connector connected to an end surface of the inboard blade portion, and wherein the cable connection point is on the connector, wherein the connector is for connecting the end surface of the inboard blade portion to an end surface of an outboard blade portion to connect the inboard blade portion and the outboard blade portion to each other at a split position of the segmented wind turbine blade having substantially the same structure as an operational segmented wind turbine blade.

The wind turbine blade specimen may further comprise an extension member connected to the connector and extending away from the inboard blade portion.

The first actuator may apply the first load to achieve a pre-determined bending moment distribution along the wind turbine blade specimen during a static or fatigue test of the wind turbine blade specimen.

The cable may be tensioned to achieve a pre-determined step change and/or change of slope in the bending moment distribution along the wind turbine blade specimen at the location of the cable connection point during the static or fatigue test of the wind turbine blade specimen. The change of slope in the bending moment distribution is due to the reduced blade root bending moment as a result of the loads relief provided by the blade connecting members. The slope has a reduced gradient just inboard of the cable connection point compared to the slope just outboard of the cable connection point in the blade spanwise direction. The step change in the bending moment distribution is due to the offset between the cable connection point and the blade neutral axis, which offset causes a moment to be applied at that point. Where the cable forms an acute angle with the neutral axis there is an additional benefit of the relieving load as a sin of the cable angle which increases linearly with the increase in lever arm towards the root end of the blade.

The first actuator may apply the first load to excite the wind turbine blade specimen at a natural frequency of the wind turbine blade specimen to generate the pre-determined bending moment distribution.

The at least one cable may be tensioned to provide a substantially constant tensile load in the cable as the wind turbine blade specimen deflects under the first load applied by the first actuator.

The at least one cable may be tensioned to provide a variable tensile load in the cable as the wind turbine blade specimen deflects under the first load applied by the first actuator.

At least two of the cables may be connected to the cable connection point on the wind turbine blade specimen so as to apply a moment, but not a couple, to the wind turbine blade specimen at the cable connection point.

The first load applied by the first actuator may be a pull down load during both a flatwisestatic test and a reverse flatwise static test of the wind turbine blade specimen, and wherein the at least one cable extends away from the cable connection point above the wind turbine blade specimen in the flatwise test, and wherein the at least one cable extends away from the cable connection point below the wind turbine blade specimen in the reverse flatwise test.

The static and fatigue tests may be carried out with the wind turbine blade specimen in a zero or 180 degree pitch orientation with respect to the horizontal.

A yet further aspect of the invention provides an apparatus for testing a wind turbine blade specimen, the apparatus comprising:
a wind turbine blade specimen comprising a portion of a segmented wind turbine blade and a connector connected to an end surface of the blade portion, wherein the connector is for connecting the end surface of the blade portion to an end surface of another blade portion to connect the blade portions to each other at a split position of the segmented wind turbine blade having substantially the same structure as an operational segmented wind turbine blade;
a first support for holding a first end of the wind turbine blade specimen,
a first actuator for applying a first load at a first location on the wind turbine blade specimen away from the first end.

The term operational wind turbine blade is used here to refer to a production blade, intended for commercial power generating operation, whether current or future operation, and is to be distinguished from a pre-production or test blade intended solely for testing or validation purposes. Of course, a pre-production or test blade could also be used for commercial power generating operation later and then would not be solely for testing or validation purposes.

The portion of the segmented wind turbine blade may be an inboard blade portion. The inboard blade portion may have a root end and a tip end, and the first support is for holding the root end, and the end surface is at the tip end.

Having the connector attached to the end surface at the tip end of the inboard blade portion of the segmented wind turbine blade may be advantageous for one or more of the following reasons. The connector has a mass, which may be a significant mass, and this may alter the natural frequency of the blade specimen and may also reduce or alleviate the need to add additional masses to the blade specimen for any other reason for the testing. Furthermore, the connector may provide a convenient location for attaching the first actuator so that the first actuator does not require additional attachment devices, such as a blade clamp, for connection of the blade specimen. Yet further, the presence of the connector may be used to measure the connection, e.g. bolting, loads between the connector and the tip end of the inboard blade portion during the test so that this connection does not need to be tested separately.

The portion of the segmented wind turbine blade is an outboard blade portion. The outboard blade portion may have a root end and a tip end, and the connector connects the end surface at the root end to the first support.

Using the connector to connect the outboard blade portion to the first support may be advantageous for transferring load between the end surface at the root end and the first support.

The wind turbine blade specimen may further comprise an extension member connected to the connector and extending away from the inboard blade portion. The cable connection point may be on the extension member.

The first load to be applied by the first actuator may be a point load.

The first load to be applied by the first actuator may be a distributed load.

The first load to be applied by the first actuator may be a static load for subjecting the wind turbine blade specimen to a static load test.

The first load to be applied by the first actuator may be an excitation load for subjecting the wind turbine blade specimen to a fatigue load test.

The first load to be applied by the first actuator may be generally perpendicular to a neutral axis of the wind turbine blade specimen when viewing in the blade chordwise direction.

The first load to be applied by the first actuator may be generally perpendicular to a neutral axis of the wind turbine blade specimen when viewing in the blade thickness direction.

The apparatus may further comprise one or more blade clamps for securing around the wind turbine blade specimen and coupled to the first actuator for transferring the first load to the wind turbine blade specimen.

The first support may be adjustable to orient the first end of the wind turbine blade specimen at one of a plurality of angles with respect to the horizontal.

A yet further aspect of the invention provides a method of testing a wind turbine blade specimen comprising:
providing a wind turbine blade specimen comprising a portion of a segmented wind turbine blade and a connector connected to an end surface of the blade portion, wherein the connector is for connecting the end surface of the blade portion to an end surface of another blade portion to connect the blade portions to each other at a split position of the segmented wind turbine blade having substantially the same structure as an operational segmented wind turbine blade;
supporting a first end of the wind turbine blade specimen; and
using a first actuator to apply a first load at a first location on the wind turbine blade specimen away from the first end; and
measuring one or more parameters of the wind turbine blade specimen.

The split position may be located between 10% and 60% of the span of the whole of the segmented wind turbine blade. The whole span is between the root end and the tip end of the entire blade. The split position may be radially inboard of 50% of the span, or radially inboard of 45% of the span, preferably around 35-40% of the span.

The connector may be connected to the end surface of the inboard blade portion and to the end surface of the outboard blade portion by fasteners.

The portion of the segmented wind turbine blade may be an inboard blade portion. The inboard blade portion may have a root end and a tip end, and the first support is for holding the root end, and the end surface is at the tip end.

The first load applied to the inboard blade portion may be applied up to a first load level due to expected loads from a first outboard blade portion intended to be coupled with the inboard blade portion. The method may further comprise repeating the testing of the same inboard blade portion specimen by applying the first load to the inboard blade portion from the first load level up to a second load level due to expected loads from a second outboard blade portion intended to be coupled with the inboard blade portion, wherein the second outboard blade portion is different than the first outboard blade portion and imparts higher expected loads to the inboard blade portion than did the first outboard blade portion.

This may enable reduced testing time of the inboard blade portion for testing a family of blades of different spanwise lengths where the inboard blade portion may be common amongst the family of blades and to be used with one of a plurality of outboard blade portions of different lengths.

The portion of the segmented wind turbine blade may be an outboard blade portion. The outboard blade portion may have a root end and a tip end, and a mounting connector connects the end surface at the root end to the first support.

The mounting connector may be, or may include, the connector for the operational segmented wind turbine blade. The mounting connector may therefore have the same structure as the connector to be used on the operational wind turbine blade. Alternatively, the mounting connector may include the connector and may further include an adaptor for coupling the connector to the first support. The adaptor may be separate from the connector or may be integrally formed with the connector. Further alternatively, the mounting connector may be a bespoke part having a first face for connecting to the first support and a second face for connecting to the end surface at the root end of the outboard blade portion.

The wind turbine blade specimen may further comprise an extension member connected to the connector and extending away from the inboard blade portion. The cable connection point may be on the extension member.

### BRIEF DESCRIPTION OF THE DRAWINGS

Embodiments of the invention will now be described with reference to the accompanying drawings, in which:

FIG. 1 shows a front view of a wind turbine according to a first example;

FIG. 2 shows a side view of the wind turbine;

FIG. 3 shows a wind turbine according to a second example;

FIG. 4 shows a wind turbine blade;

FIG. 5 shows an exploded view of a connection joint;

FIG. 5a shows a partial sectional view through the connection joint on one side of the blade shell;

FIG. 6 shows a detail view of the connection joint;

FIGS. 7a and 7b show side and plan views of a testing apparatus with a loads assembly and a blade specimen for testing;

FIGS. 8a and 8b show side and plan views of a testing apparatus with a loads assembly and a blade specimen for testing;

FIGS. 9a and 9b show side and plan views of a testing apparatus with a loads assembly and a blade specimen for testing;

FIGS. 10a and 10b show plan and side views of a testing apparatus with a loads assembly and a blade specimen for testing;

FIGS. 11a and 11b show plan and side views of a testing apparatus with a loads assembly and a blade specimen for testing;

FIGS. 12a and 12b show plan and side views of a testing apparatus with a loads assembly and a blade specimen for testing;

FIG. 13 shows a detail view of a loads assembly;

FIG. 14 shows a bending moment distribution diagram for a blade specimen;

FIG. 15 shows a side view of a loads assembly;

FIG. 16 shows a side view of a loads assembly;

FIG. 17 shows a side view of a loads assembly;

FIG. 18 shows a side view of a loads assembly;

FIGS. 19 and 20 shows side and plan views of a loads assembly;

FIGS. 21 and 22 shows side and plan views of a loads assembly;

FIG. 23 shows a side view of a testing apparatus with a loads assembly and a blade specimen for testing;

FIG. 24 shows a plan view of a testing apparatus with a loads assembly and a blade specimen for testing;

FIG. 25 shows a side view of a testing apparatus and a blade specimen for testing;

FIG. 26 shows a plan view of a testing apparatus and a blade specimen for testing;

FIG. 27 shows a side view of a testing apparatus with a loads assembly and a blade specimen having an extension member for testing;

FIG. 28 shows a plan view of a testing apparatus with a loads assembly and a blade specimen having an extension member for testing;

FIG. 29 shows a side view of a testing apparatus and a blade specimen for testing;

FIG. 30 shows a plan view of a testing apparatus and a blade specimen for testing;

FIG. 31 shows a mounting connector including a connector and an adaptor;

FIG. 32 shows a side view of a testing apparatus with a loads assembly and a blade specimen;

FIG. 33 shows a simplified loads diagram of the setup shown in FIG. 32; and

FIG. 34 shows a sample bending moment distribution for the setup shown in FIG. 32.

FIG. 35 shows a test arrangement employing a single cable.

### DETAILED DESCRIPTION OF EMBODIMENT(S)

In this specification, terms such as leading edge, trailing edge, pressure surface, suction surface, thickness, and chord are used. While these terms are well known and understood to a person skilled in the art, definitions are given below for the avoidance of doubt.

The term leading edge is used to refer to an edge of the blade which will be at the front of the blade as the blade rotates in the normal rotation direction of the wind turbine rotor.

The term trailing edge is used to refer to an edge of a wind turbine blade which will be at the back of the blade as the blade rotates in the normal rotation direction of the wind turbine rotor.

The chord of a blade is the straight line distance from the leading edge to the trailing edge in a given cross section perpendicular to the blade spanwise direction. The term chordwise is used to refer to a direction from the leading edge to the trailing edge, or vice versa.

A pressure surface (or windward surface) of a wind turbine blade is a surface between the leading edge and the trailing edge, which, when the blade is in use, has a higher pressure than a suction surface of the blade.

A suction surface (or leeward surface) of a wind turbine blade is a surface between the leading edge and the trailing edge, which will have a lower pressure acting upon it than that of a pressure surface, when the blade is in use.

The thickness of a wind turbine blade is measured perpendicularly to the chord of the blade and is the greatest distance between the pressure surface and the suction surface in a given cross section perpendicular to the blade spanwise direction.

The term spanwise is used to refer to a direction from a root end of a wind turbine blade to a tip end of the blade, or vice versa. When a wind turbine blade is mounted on a wind turbine hub, the spanwise and radial directions will be substantially the same.

The term spar cap is used to refer to a longitudinal, generally spanwise extending, reinforcing member of the blade. The spar cap may be embedded in the blade shell or may be attached to the blade shell. The spar caps of the windward and leeward sides of the blade may be joined by one or more shear webs extending through the interior hollow space of the blade. The blade may have more than one spar cap on each of the windward and leeward sides of the blade. The spar cap may form part of a longitudinal reinforcing spar or support member of the blade. In particular, the spar caps may form part of the load bearing structure extending in the longitudinal direction that carries the flap-wise bending loads of the blade. The spar cap may comprise spar cap portions either side of a connection joint between portions of the blade in the case of a segmented or split wind turbine blade.

The term outboard refers to a radial (blade spanwise) direction from hub of the blade towards the tip end of the blade. The term inboard refers to a radial direction from the tip end of the blade towards the hub.

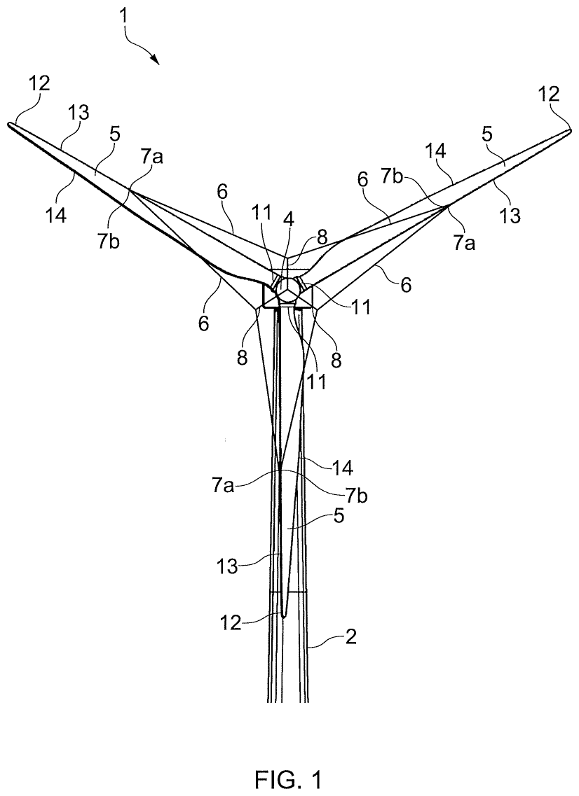

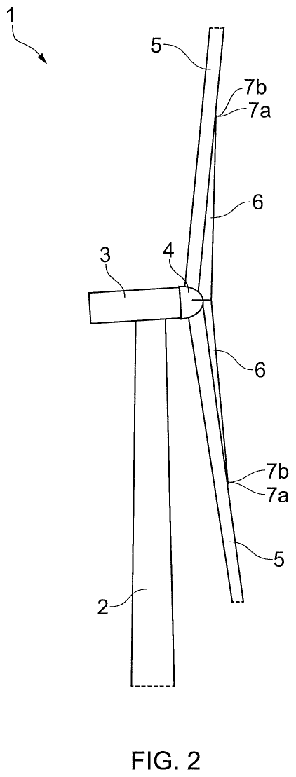

FIGS. 1 and 2 show a pitch controlled wind turbine 1 according to a first example. FIG. 1 is a front view of the wind turbine 1, and FIG. 2 is a side view of the wind turbine 1. The wind turbine 1 comprises a tower 2 and a nacelle 3 mounted on the tower 2. A hub 4 is mounted rotatably on the nacelle 3, and carries three wind turbine blades 5 projecting outwardly from the nacelle 3. The hub 4 and blades 5 collectively form part of a rotor of the wind turbine 1. While the example shown in FIGS. 1 and 2 has three blades 5, it will be appreciated that other numbers of blades 5 are possible.

When wind blows against the wind turbine 1, the wind turbine blades 5 generate a lift force which causes a generator (not shown) within the nacelle 3 to generate electrical energy.

It will be appreciated that the wind turbine 1 depicted may be any suitable type of wind turbine 1. The wind turbine 1 shown is an upwind wind turbine, although it will be appreciated the wind turbine 1 may be a downwind wind turbine. The wind turbine 1 may be an onshore wind turbine such that the foundation is embedded in the ground, or the wind turbine 1 may be an offshore installation in which case the foundation would be provided by a suitable marine platform.

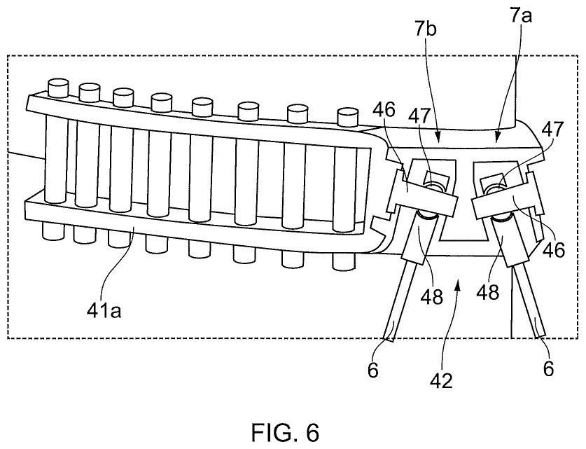

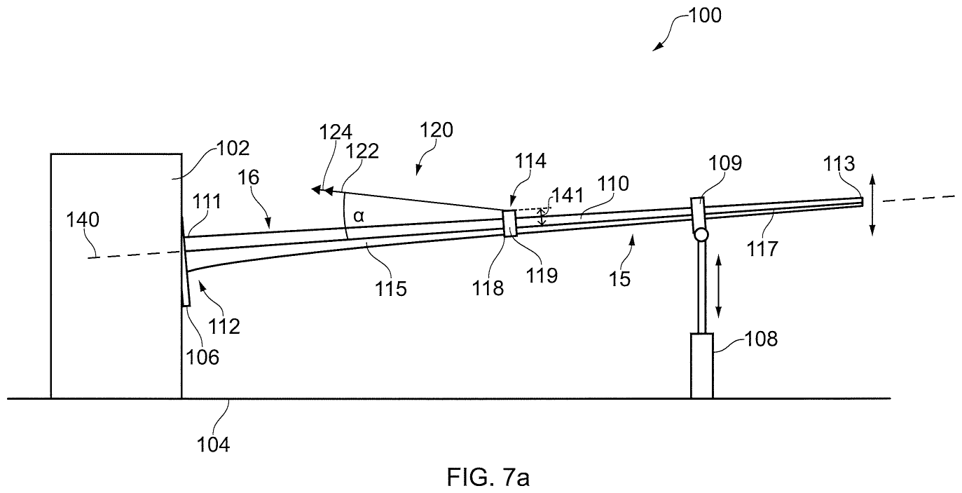

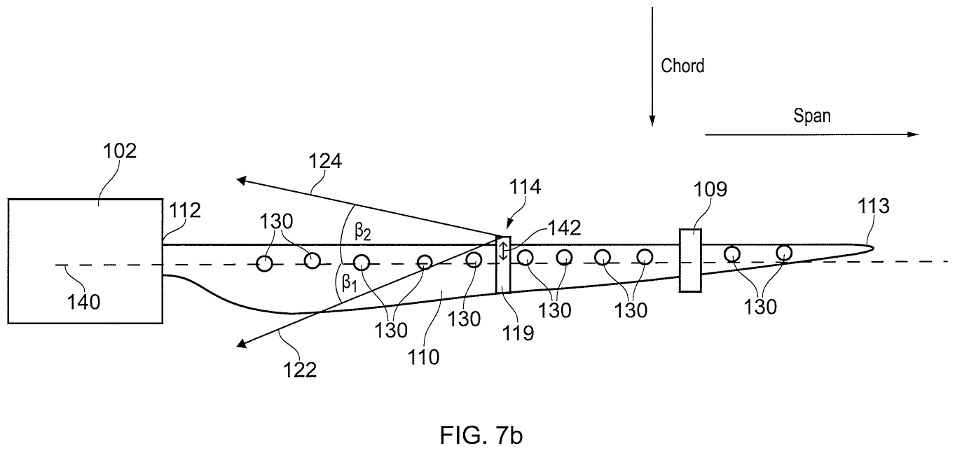

Three blade connecting members 6 interconnect neighbouring wind turbine blades 5 between connection points 7a, 7b on the wind turbine blades 5 (such as shown in further detail in FIGS. 6 and 7). The connecting members 6 are cables, e.g. steel or polymer cables.

A pre-tension member 8 may extend between one of each of the blade connecting members 6 and a common point arranged at or adjacent the hub 4. In the example shown in FIGS. 1 and 2, the pre-tension members 8 extend to the hub 4. The pre-tension members 8 are configured to provide pre-tension in the blade connecting members 6. The pre-tension members 8 are cables, e.g. steel or polymer cables.

In the absence of pre-tension members 8, the blade connecting members 6 may extend substantially straight to interconnect neighbouring wind turbine blades 5 between connection points 7a, 7b on the wind turbine blades 5 and may be pre-tensioned by a tensioning device (not shown) within each blade 5.

The pre-tensioned blade connecting members 6 cause the wind turbine blades 5 to mutually support each other, in the sense that loads on the wind turbine blades 5, in particular edgewise loads and forward flatwise loads, are ‘shared’ among the wind turbine blades 5. The wind turbine is preferably an upwind wind turbine.

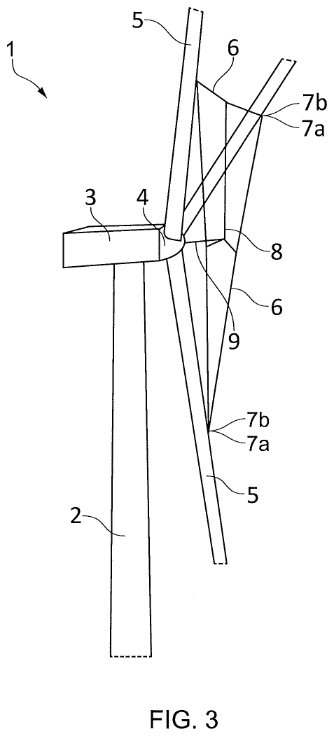

FIG. 3 is a side view of a pitch controlled wind turbine 1 according to a second example. The wind turbine 1 of FIG. 3 is similar to the wind turbine 1 of FIGS. 1 and 2, and therefore likewise features will not be described in detail here.

In FIG. 3, the pre-tension members 8 are not connected directly to the hub 4. Instead, the pre-tension members 8 are connected adjacent the hub 4, to a hub member 9 which extends from the hub 4 substantially along a direction defined by a rotational axis of the hub 4. As a result, the connection point of the pre-tension members 8 is further from the hub 4 than the example of FIGS. 1 and 2, and thereby further from the positions where the wind turbine blades 5 are connected to the hub 4. This has the consequence that the pre-tension members 8 may also pull the blade connecting members 6 away from the hub 4 and away from the tower 2. This may also cause the wind turbine blades 5 to be pulled in this direction, thereby further reducing edgewise and forward flatwise loads at the root of the wind turbine blades 5 and securing tower clearance, similar to what is obtained when a coning angle is introduced. Due to the use of connecting members 6, this has been found to tend to lead to increased stiffness in the inner part of the blades 5.

The wind turbine blades 5 have a root end 11 proximal to the hub 4, adapted to be connected to the hub 4 via a pitch mechanism, and a tip end 12 distal from the hub 4. The blades 5 include a leading edge 13 and a trailing edge 14 that extend between the respective root end 11 and tip end 12. The blades 5 include a blade shell that defines a suction side 15 and a pressure side 16 around the blade. A thickness dimension of the blade 5 extends between the suction side 15 and the pressure side 16.

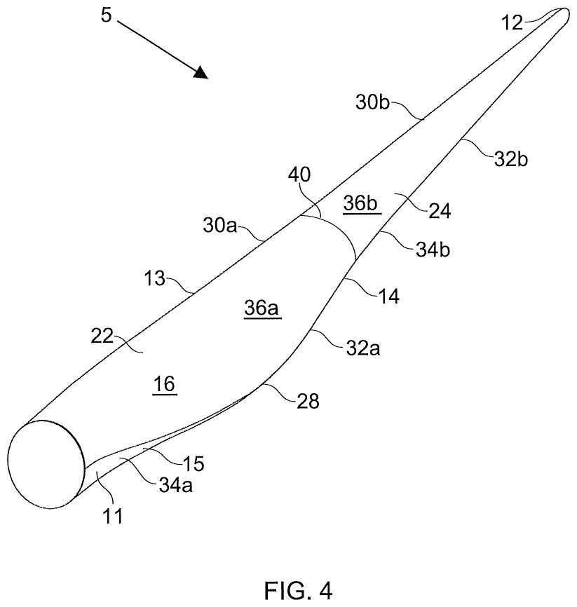

As shown in FIG. 4, each blade 5 may have a cross section which has a substantially circular profile near the root end 11. The blade 5 may transition from a circular profile to an aerofoil profile moving from the root end 11 of the blade 5 outboard. The blade 5 may comprise a “shoulder” 28 outboard of the root end 11, which is the widest part of the blade where the blade 5 has its maximum chord. The blade 5 may have an aerofoil profile of progressively decreasing thickness in an outboard portion of the blade. The progressively decreasing thickness may extend from the shoulder 28 to the tip end 12.

The connecting points 7a, 7b are located forward of the leading edge 13 and adjacent the pressure side 16 on a leading edge extension of the respective blade 5. The connecting points may be between 10% and 60% of the length of the wind turbine blade 5 from the root end 11 to the tip end 12 in the radial direction but are preferably radially inboard of 50% of the length of the wind turbine blade 5 from the root end 11 to the tip end 12, and more preferably radially inboard of 45% of the length of the wind turbine blade 5 from the root end 11 to the tip end 12, e.g. around 35-40%.

Each of the blades 5 may be a split or segmented blade formed of a first blade portion 22 and a second blade portion 24 coupled together, such as shown in FIG. 4. Each blade portion 22, 24 has a shell that defines a respective leading edge 30a, 30b, trailing edge 32a, 32b, suction side 34a, 34b, and pressure side 36a, 36b.

The first portion 22 and second portion 24 of each blade 5 may be connected at a connection joint indicated by connection line 40. The connection line 40 or split position between the first and second blade portions 22, 24 may be a spanwise split, with the connection line 40 being chordwise. The first blade portion 22 extends from the blade root 11 to the connection line 40. The second blade portion 24 extends from the blade connection line 40 to the blade tip 12. The connection joint or split position may be located between 10% and 60% of the span of the whole of the segmented wind turbine blade, the whole span being between the root end 11 and the tip end 12. The split position may be radially inboard of 50% of the span, or radially inboard of 45% of the span, preferably around 35-40% of the span.

It will be appreciated that the blade 5 may have any number of blade portions 22, 24, with respective connection joints between them.

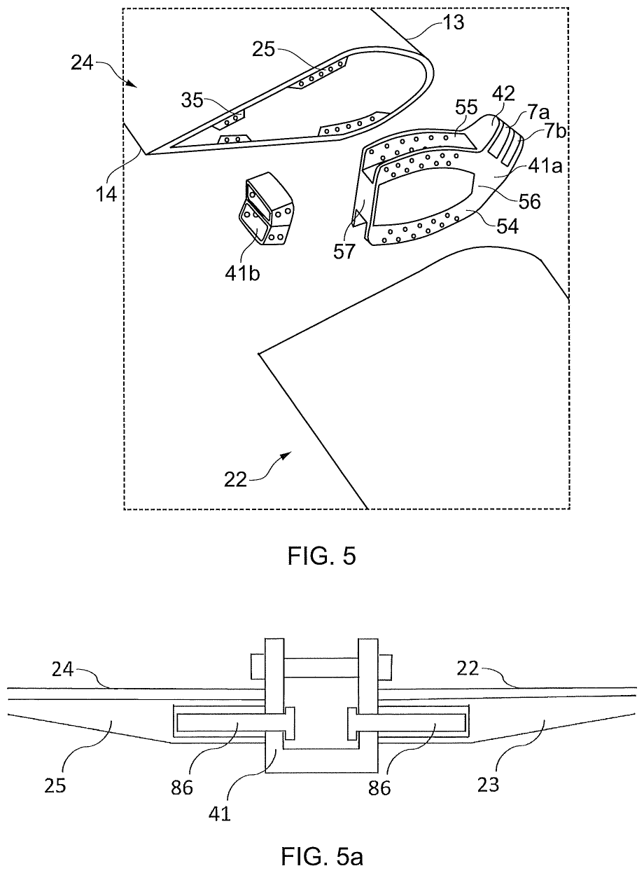

As previously referred to above, the first and second blade portions 22, 24 are coupled by a connection joint that includes a connector 41. The connector may comprise a first connector 41a and a second connector 41b, such as shown in FIGS. 5 and 6. The following description is made in relation to a connector 41 comprising a first connector 41a and a second connector 41b, however it will be appreciated that the description may similarly be applied to a connector comprising a first connector 41a only.

The connector 41 connects a first blade end surface of the first blade portion 22 to a second blade end surface of the second blade portion 24. As explained in further detail below, the connection points 7a, 7b of the connecting members 6 are on the first connector 41a at the connection joint. The connector 41 may be connected to the first blade end surface and to the second blade end surface by fasteners. The fasteners may be removable fasteners for assembly and disassembly of the joint.

The connector 41 is adapted to transfer load between the first blade portion 22 and the second blade portion 24, and in particular between a first spar cap portion 23 of the first blade portion 22 and a second spar cap portion 25 of the second blade portion 24, as shown in FIG. 5a.

The first connector 41a and the second connector 41b may be cast metallic components, although it will be appreciated that each may be formed of any suitable materials, e.g. composite materials, and produced by any suitable manufacturing technique, e.g. machined, co-cured or co-bonded. The first connector 41a and second connector 41b may be made from aluminium. Each of the first connector 41a and the second connector 41b are a single unitary connector component, although it will be appreciated that each connector 41a, 41b may be formed of two or more components in some examples.

In the example shown in FIG. 5, the first connector 41a includes a first branch 54 for connecting the suction side 15 of the first and second blade portions 22, 24 and a second branch 55 for connecting the pressure side 16 of the first and second blade portions 22, 24. The first and second branches 54, 55 may be connected by a first link 56 located towards the leading edge 13 of the blade 5 and connected by a second link 57 located towards the trailing edge 14 of the blade 5. In this way, a ring shape is formed by the first branch 54, second branch 55, first link 56 and second link 57. The first and second branches 54, 55 may be integrally formed with the first and second links 56, 57, although it will be appreciated that the first and second branches 54, 55 may be separate components from each other, and/or the first and second links 56, 57. It will be appreciated that the first connector 41a may take other forms, for example the second link 57 may be located away from the trailing edge 14 of the blade 5 so as to form a generally ‘A’ shaped connector.

Should the first connector 41a be used without a second connector 41b, the first connector 41a may extend across substantially the entire chord of the wind turbine blade 5, although preferably the connector 41a extends across only a portion of the chord of the wind turbine blade, such as shown in FIG. 5. This assists in reducing the weight of the first connector 41a, whilst allowing the first connector 41a to be positioned adjacent the spar cap portions of the blade portions 22, 24 that may carry the majority of the loads. The first connector 41a may include a plurality of apertures. In this manner, the first and second blade portions 22, 24 may be attached together with sets of fasteners 86 that extend through the holes, as shown in FIG. 5a.

The first connector 41a may extend across any chordwise portion of the blade 5 adjacent the spar cap portions 25.

In some examples, the connection joint may comprise multiple, discrete, connectors 41a, 41b separated in a generally chordwise direction. This may assist in minimising the weight of the connection joint, as the connectors 41a, 41b can support discrete portions of the connection joint, where required, without requiring the connector(s) to span therebetween.

The first connector 41a is located towards the leading edge 13 of the blade 5, and may be arranged to extend up to the leading edge 13 of the blade 5. Further, the first connector 41a may comprise a leading edge extension 42 that includes connection points 7a, 7b that attach to connecting members 6.

A second connector 41b is located towards the trailing edge 14 with respect to the first connector 41a. The second connector 41b may connect to spar cap portions on the first blade section 22 (not shown) and spar cap portions 35 on the second blade section 24. The second connector 41b may include a first set of fasteners (not shown) for extending into the spar cap portion on the first blade section 33, and a second set of fasteners (not shown) for extending into the spar cap portion 35 on the second blade section 24, with the second connector 41b including a plurality of apertures through which the sets of fasteners extend so as to secure the connector 41b to the spar cap portions on the first blade section 22 and the second blade section 24.

Any reference to the connector 41 made hereinafter may refer to a connector comprising a first connector 41a only or a connector comprising both a first connector 41a and a second connector 41b.

As shown in FIG. 6, the leading edge extension 42 includes connection points 7a, 7b that attach to the connecting members 6. In the present example, the leading edge extension 42 includes first and second connection points 7a, 7b, although in alternative examples the leading edge extension 42 may comprise any suitable number of connection points. The first and second connection points 7a, 7b may be arranged forward of the leading edge 13 and adjacent the pressure side 16, such as shown in FIG. 5. This provides additional clearance for the connecting members 6 as the wind turbine blades 5 rotate with the hub 4 about the nacelle 3. In particular, sufficient clearance is provided between the connecting members 6 and the first blade portion 22 when the blades 5 are pitched between about −5 degrees and +95 degrees.

It will be appreciated that the connection points 7a, 7b may be adjacent each other on the leading edge extension 42. Alternatively, the connection points 7a, 7b may be spaced from one another. For example, a second connection point 7b may be located further towards the pressure side 16 than the first connection point 7a, e.g. the second connection point 7b may be closer to the pressure side spar cap 23,25 whereas the first connection point may remain adjacent the leading edge 13.

In some examples, the connector 41a may include multiple leading edge extensions 42 integrally formed with the connector 41a. The leading edge extensions may be spaced from each other, for example one may be located further towards the pressure side 16 than the other, with each leading edge extension 42 having a respective connection point 7a, 7b.

The connection points 7a, 7b may permit at least some freedom of movement of the connecting members 6 at its respective connection point. In the example shown in FIG. 6, the connection points 7a, 7b permit rotation of each blade connecting member 6 about the respective connection point 7a, 7b in two orthogonal rotational degrees of freedom. This allows each connecting member 6 to move independently of each other, thereby reducing constraints on the wind turbine 1.

The two orthogonal rotational degrees of freedom may be provided by a bearing structure, for example as shown in FIG. 6. In this example, the first rotational freedom is provided by a pin 46 of the bearing structure about which a respective blade connecting member 6 is rotatable, and the second rotational freedom provided by a spherical plain bearing 47 between the pin 46 and the respective connecting member 6. However, it will be appreciated that other bearing structures may be applicable.

To assist in attaching the connecting members 6 to the bearing structure, each connecting member 6 may include an eyelet 48 at one end for receiving the respective pin 46.

Each connecting member 6 is connected at the first connection point 7a to one wind turbine blade 5 and at the second connection point 7b to a neighbouring wind turbine blade, such as previously described in relation to FIGS. 1 to 3.

Apparatus 100 and methods for testing a wind turbine blade typically provide for testing a wind turbine blade specimen 110 having the same or similar characteristics to a production wind turbine blade to meet certification requirements for the production blade. The wind turbine blade specimen 110 typically undergoes a variety of static and fatigue loading tests. The wind turbine blade specimen 110 may be tested cantilevered from a first support 102 for holding a first end 112 of the wind turbine blade specimen. The first support 102 is rigidly fixed to the ground 104. The first support 102 may have a mounting portion 106 to which the first end 12 of the wind turbine blade specimen 110 is fastening, e.g. by bolting.

The mounting portion 106 may be pivotably mounted within the first support 102 for varying the angle of inclination of the wind turbine blade specimen 110 relative to the ground 104, more specifically the angle that the neutral axis 140 of the wind turbine blade specimen 110 at the first end 112 makes with the plane of the ground 104. The mounting portion 106 may also be rotatably mounted within the first support 102 for varying the pitch angle of the wind turbine blade specimen 110. At a zero pitch angle the chord of the wind turbine blade specimen 110 is parallel to the ground plane.

In a typical testing regime, the wind turbine blade specimen 110 may undergo a flatwise static load test, a reverse flatwise static load test, an edgewise static load test, a reverse edgewise static load test, a flatwise fatigue load test, and an edgewise fatigue load test, amongst others. A set of strain gauges on the wind turbine blade specimen 110 may be used to measure strains or bending moments at various points on the wind turbine blade specimen 110 during each of the tests.

In a flatwise static load test the wind turbine blade specimen 110 may be orientated at a zero pitch angle with the suction side 15 of the wind turbine blade specimen 110 facing towards the ground 104. A first load applied at a first location on the wind turbine blade specimen 110 away from the first end 112 deflects the wind turbine blade specimen 110 towards the ground 104 to mimic the maximum flatwise static design load the wind turbine blade specimen 110 is expected to withstand. The first load may be a distributed load, such as by using a series of grounded winches each connected to respective blade clamps towards the free end of the cantilevered wind turbine blade specimen 110. The wind turbine blade specimen 110 may be inclined relative to the ground 104 such that at full deflection the first load is applied perpendicular to the wind turbine blade specimen 110.

In a reverse flatwise static load test the wind turbine blade specimen 110 may be orientated at a 180 degree pitch angle with the pressure side 16 of the wind turbine blade specimen 110 facing towards the ground 104. A first load applied at a first location on the wind turbine blade specimen 110 away from the first end 112 deflects the wind turbine blade specimen 110 towards the ground 104 to mimic the maximum reverse flatwise static design load the wind turbine blade specimen 110 is expected to withstand. The first load may be a distributed load, such as by using a series of grounded winches each connected to respective blade clamps towards the free end of the cantilevered wind turbine blade specimen 110. The wind turbine blade specimen 110 may be inclined relative to the ground 104 such that at full deflection the first load is applied perpendicular to the wind turbine blade specimen 110.

In a flatwise fatigue load test the wind turbine blade specimen 110 may be orientated at a zero pitch angle with the suction side 15 of the wind turbine blade specimen 110 facing towards the ground 104. A first load applied at a first location on the wind turbine blade specimen 110 away from the first end 112 excites the wind turbine blade specimen 110 to oscillate at a natural frequency of the wind turbine blade specimen 110. The first load may be a point load, such as by using a grounded linear actuator connected to a blade clamp. The wind turbine blade specimen 110 flaps up and down towards and away from the ground 104 for a predetermined number of cycles to mimic the sum of dynamic cycles of varying magnitude the production blade may be expected to experience in its lifetime. The wind turbine blade specimen 110 may be inclined relative to the ground 104 such that at full deflection the cantilevered free end of the blade specimen does not contact the ground 104 and the grounded linear actuator when fully retracted has clearance between the ground 104 and the blade specimen 110.

In an edgewise static load test the wind turbine blade specimen 110 may be orientated at a zero pitch angle with the suction side 15 of the wind turbine blade specimen 110 facing towards the ground 104. A first load applied at a first location on the wind turbine blade specimen 110 away from the first end 112 deflects the cantilevered free end of the wind turbine blade specimen aft generally parallel to the chord of the wind turbine blade specimen 110 to mimic the maximum edgewise static design load the wind turbine blade specimen 110 is expected to withstand. The first load may be a point load, such as by using a grounded linear actuator connected to a blade clamp.

In a reverse edgewise static load test the wind turbine blade specimen 110 may be orientated at a zero pitch angle with the suction side 15 of the wind turbine blade specimen 110 facing towards the ground 104. A first load applied at a first location on the wind turbine blade specimen 110 away from the first end 112 deflects the cantilevered free end of the wind turbine blade specimen forward generally parallel to the chord of the wind turbine blade specimen 110 to mimic the maximum reverse edgewise static design load the wind turbine blade specimen 110 is expected to withstand. The first load may be a point load, such as by using a grounded linear actuator connected to a blade clamp.

In an edgewise fatigue load test the wind turbine blade specimen 110 may be orientated at a zero pitch angle with the suction side 15 of the wind turbine blade specimen 110 facing towards the ground 104. A first load applied at a first location on the wind turbine blade specimen 110 away from the first end 112 excites the wind turbine blade specimen 110 to oscillate at a natural frequency of the wind turbine blade specimen 110. The first load may be a point load, such as by using a grounded linear actuator connected to a blade clamp. The wind turbine blade specimen 110 flaps (oscillates) fore and aft generally parallel to the chord of the wind turbine blade specimen 110 for a predetermined number of cycles to mimic the sum of dynamic cycles of varying magnitude the production blade may be expected to experience in its lifetime.

Where the wind turbine blade specimen 110 to be tested is for testing the design of a wind turbine rotor having pre-tensioned blade connecting members 6, similar to that described above with reference to FIGS. 1 to 6, then the blade connecting members 6, e.g. cables connected between each of the blades 5 of the rotor, will provide loads relief to the part of the wind turbine blade 5 inboard of the connection points 7a, 7b, notably in the forward flatwise direction of a static test or when the blade is being driven in this direction during a fatigue test. Load relief is also provided in the edgewise static or fatigue tests. This loads relief therefore needs to be substantially reproduced during the testing of the wind turbine blade specimen 110.

Conventional methods of testing a wind turbine blade specimen 110 typically apply a load or set of loads to the wind turbine blade specimen 110 to target a bending moment distribution along the spanwise length of the wind turbine blade specimen 110. Testing a wind turbine blade specimen 110 for testing the design of a wind turbine rotor having pre-tensioned blade connecting members 6 would be no different in that a target bending moment distribution along the spanwise length of the wind turbine blade specimen 110 would be calculated for each of the static or fatigue tests such as those detailed above.

The target bending moment distribution along the wind turbine blade specimen 110 is achieved through the first load applied by a first actuator 108 at the first location on the wind turbine blade specimen 110 away from the first end 112, and additionally by a load assembly 120 configured such that the load imparted to the wind turbine blade specimen 110 by the first actuator 108 is partially supported by the load assembly 120.

The wind turbine blade specimen 110 has a cable connection point 114 at a second location on the wind turbine blade specimen away from the first end 112. The load assembly 120 has at least one cable 122 for coupling to the cable connection point 114. The cable 122 is configured to carry tensile load such that the load imparted to the wind turbine blade specimen by the first actuator 108 is partially supported by the cable 122.

The load assembly 120 may include a plurality of cables 122, 124. The cables may be coupled to the same cable connection point 114 on the wind turbine blade specimen 110.

The one or more cables 122, 124 of the load assembly 120 may be arranged to apply a similar tensile load vector to the wind turbine blade specimen 110 at the cable connection point 114 as those that a production wind turbine blade validated by the test would experience. Importantly, the deflection of the wind turbine blade specimen 110 during the various tests will move the position of the cable connection point 114 and therefore the cable 122, 124 attached to the cable connection point 114 will move. These cable deflections need to be accommodated by the load assembly 120 to achieve the desired bending moment distribution for the wind turbine blade specimen 110 during the full range of displacements of the wind turbine blade specimen 110 during the tests. The target bending moment distribution may be constrained by the available space for the testing apparatus 110. For example, the building in which the testing apparatus 100 is located may have space constraints that require certain compromises in the setup of the testing apparatus, in particular of the load assembly 120.

The cable connection point 114 may be located a distance from a neutral axis 140 of the wind turbine blade specimen 110. The cable connection point 114 may be located a distance 142 from the neutral axis of the wind turbine blade specimen in the blade chordwise direction and/or a distance 141 from the neutral axis of the wind turbine blade specimen in the blade thickness direction. This offset distance between the cable connection point 114 and the neutral axis means that the tensile load in the cable 122, 124 provides a pure moment as well as a moment due to the offset distance. These moments created by the load assembly 120 both have an influence on the bending moment distribution of the wind turbine blade specimen 110 so that the bending moment distribution achieved during the test meets the target bending moment distribution.

The cable(s) 122, 124 may each extend from the cable connection point 114 at an angle with respect to a neutral axis 140 of the wind turbine blade specimen. The angle is an acute angle, which may be less than 45 degrees, or less than 30 degrees, or less than 25 degrees.

The cable 122 may extend from the cable connection point 114 at a first angle alpha (α) with respect to the neutral axis of the wind turbine blade specimen when viewing the wind turbine blade specimen along the blade chordwise direction and/or at a second angle beta (β) with respect to the neutral axis of the wind turbine blade specimen when viewing the wind turbine blade specimen along the blade thickness direction. The magnitude of the first angle may be less than the magnitude of the second angle.

Where the load assembly 120 includes a pair of cables 122, 124 coupled to the same cable connection point 114 on the wind turbine blade specimen 110 (which expression encompasses the arrangement where the connections are adjacent each other as in FIG. 6), the first angles alpha (α) of the respective cables of the pair of cables may be substantially identical and extend to the same side of the blade neutral axis 140 when viewing along the blade chordwise direction. The second angles beta (β1, β2) of the respective cables of the pair of cables may be either similar or dissimilar and extend to opposite sides of the blade neutral axis 140 when viewing along the blade thickness direction.

The wind turbine blade specimen 110 may be an entire wind turbine blade having a root 111 and a tip 113 and a span extending form the root to the tip. The span substantially corresponds to the span of an operational production wind turbine blade having substantially the same structure as the wind turbine blade specimen 110.

The wind turbine blade specimen 110 may be a segmented wind turbine blade having an inboard blade portion 115 and an outboard blade portion 117 connected to each other at a split position 118. The inboard blade portion 115 and outboard blade portion 117 may be connected by a connection joint. The connection joint may include a connector 119 connected to an end surface of the inboard blade portion 115 and to an end surface of the outboard blade portion 117. The cable connection point 114 may be on the connector 119.

The connector 119 used on the wind turbine blade specimen 110 may be substantially identical to the connector 41 used on the production wind turbine blade, such as that described above with reference to FIGS. 1 to 6. Alternatively, the connector 119 used on the wind turbine blade specimen 110 may take a different form and be used for testing purposes only.

FIGS. 7a and 7b illustrate a wind turbine blade specimen 110 arranged on testing apparatus 100 for a flatwise fatigue test. FIG. 7a shows a side view and 7b shows a plan view of the setup. In this example, the wind turbine blade specimen 110 is an entire segmented wind turbine blade having a connector 119 between inboard blade portion 115 and outboard blade portion 117. The root 111 of the wind turbine blade specimen 110 is held by first support 102 rigidly fixed to the ground 104. The wind turbine blade specimen 110 is cantilevered from the first support 102 by attachment of the root 111 of the wind turbine blade specimen 110 to mounting portion 106 by fasteners.

The wind turbine blade specimen 110 may be orientated at a zero pitch angle with the suction side 15 of the wind turbine blade specimen 110 facing towards the ground 104. The wind turbine blade specimen 110 may be upwardly inclined from the root 11 where upwardly means that the wind turbine blade specimen extends away from the ground 104.

In FIG. 7a the first actuator 108 may be a linear actuator, such as a hydraulic actuator. The first actuator 108 is grounded and is configured to apply a point load to the wind turbine blade specimen 110. The wind turbine blade specimen has a neutral axis 140 and the first load to be applied by the first actuator 108 is generally perpendicular to a neutral axis of the wind turbine blade specimen when viewing in the blade chordwise direction. A blade clamp 109 is secured around the wind turbine blade specimen 110 and couples the first actuator 108 to the wind turbine blade specimen 110. The first actuator 108 moves linearly in reciprocation to provide an excitation load to the wind turbine blade specimen via the blade clamp 109 so as to oscillate the wind turbine blade specimen to flap up and down. The blade clamp 109 may be positioned away from the connector 119 and preferably is positioned around the outboard portion 117 of the wind turbine blade specimen 110. However, the blade clamp 109 or attachment for coupling the first actuator 108 to the wind turbine blade specimen 110 may be provided at any spanwise location along the wind turbine blade specimen 110 away from the root 111.

The first load excites the wind turbine blade specimen 110 to oscillate at a natural frequency of the wind turbine blade specimen. The wind turbine blade specimen 110 flaps up and down towards and away from the ground 104 for a predetermined number of cycles to mimic the sum of dynamic cycles of varying magnitude the production blade may be expected to experience in its lifetime.

As is conventional, a set of strain gauges or other measurement devices 130 on the wind turbine blade specimen 110 may be used to measure the load and/or bending moment and/or deflection of the wind turbine blade specimen 110 during the test.

Cables 122, 124 are pretensioned and carry tensile load such that the load imparted to the wind turbine blade specimen by the first actuator 108 is partially supported by the cables 122, 124 which are coupled to the cable connection point 114 on the connector 119.

The cable connection point 114 is offset from the neutral axis 140 in both the blade chordwise direction and in the blade thickness direction. The cables 122, 124 each extend from the cable connection point 114 at a first angle alpha (α) of approximately 6 degrees with respect to the neutral axis of the wind turbine blade specimen when viewing the wind turbine blade specimen along the blade chordwise. The cables extend away from the pressure side 16 of the blade specimen 110, i.e. above the blade specimen in FIG. 7a.

The cable 122 extends from the cable connection point 114 at a second angle beta (β1) and the cable 124 extends from the cable connection point 114 at a second angle beta (β2), each with respect to the neutral axis of the wind turbine blade specimen when viewing the wind turbine blade specimen along the blade thickness direction. The second angles β1 and β2 are similar at around 20 degrees and extend to opposite sides of the blade neutral axis 140 when viewing along the blade thickness direction.

The excitation of the wind turbine blade specimen 110 may target a bending moment distribution along the spanwise length of the wind turbine blade specimen 110 from root 112 to tip 113.

The blade connecting members 6 on the operational wind turbine blade 5 having substantially the same structure as the wind turbine blade specimen 110 support the loads on the blade. The cables 122, 124 of the test setup are provided to mimic the load relief provided by the blade connecting members 6. The cables 122, 124 are therefore tensioned such that the target bending moment distribution for the wind turbine blade specimen 110 during the test is achieved. The target bending moment distribution accounts for both the first load induced by the first actuator 108 and also the load relief provided by the cables 122, 124 of the load assembly 120. The target bending moment distribution will have both a step change in the bending moment distribution of the blade at the location of the connector 119 and a change of slope in the bending moment distribution either side of the step due to the loads relief provided by the blade connecting members 6 of the operational wind turbine blade 5. The same (or as close as possible) change in the bending moment distribution needs to be created in the test setup by the load assembly 120. The change of slope in the bending moment distribution is due to the reduced blade root bending moment as a result of the loads relief provided by the blade connecting members 6. The slope has a reduced gradient just inboard of the cable connection point compared to the slope just outboard of the cable connection point in the blade spanwise direction. The step change in the bending moment distribution is due to the offset between the cable connection point and the blade neutral axis, which offset causes a moment to be applied at that point. There is an additional benefit of the relieving load as a sin of the first and second angles (α, β) which increases linearly with the increase in lever arm towards the root end of the blade.

The second angles β1 and β2 that the cables 122, 124 make with the blade specimen do not significantly change as the blade specimen 110 flaps up and down in the flatwise fatigue test. The second angles β1 and β2 may be selected to be similar to the angle that the blade connecting members 6 makes with the neutral axis of the operational wind turbine blade 5 but this is not essential and an angular difference between these angles can be accommodated by adjusting the tensile load in the cables 122, 124 to achieve the target bending moment distribution for the blade specimen 110.

However, the first angle alpha (α) of the cables 122, 124 will change as the blade specimen oscillates up and down. The first angle alpha (α) of the cables 122, 124 may be selected to be approximately equal to the angle that the blade connecting members 6 makes with the neutral axis of the operational wind turbine blade 5 at the mean fatigue deflection. The tensile load in the cables 122, 124 which, as mentioned above, extend away from the pressure side 16 of the blade specimen in the flatwise fatigue test, acts against gravity. The loads due to gravity are therefore also taken into account when calculating the blade specimen test setup to achieve the target bending moment distribution for the blade specimen.

The tensile load in the cables 122, 124 may be varied according to the tip deflection position of the blade specimen 110. This variable tensile load is preferable due to the changing first angles alpha that the cables 122, 124 make with the neutral axis 140 of the blade. Mechanisms for providing the cable tension and for providing a variable cable tension will be described later below. In the flatwise fatigue test of FIGS. 7a and 7b the variable cable tension may be selected to provide the target bending moment distribution as the blade specimen oscillates up and down through a range of tip deflection positions. The cable tension required at each tip deflection position to achieve the target bending moment distribution may be based upon expected flatwise static load data, a subset of which may be used in the flatwise (and reverse flatwise) static load testing, the setup of which will now be described.

The cables 122, 124 provide partial load relief to the blade at least as the blade is being driven in the downward stroke.

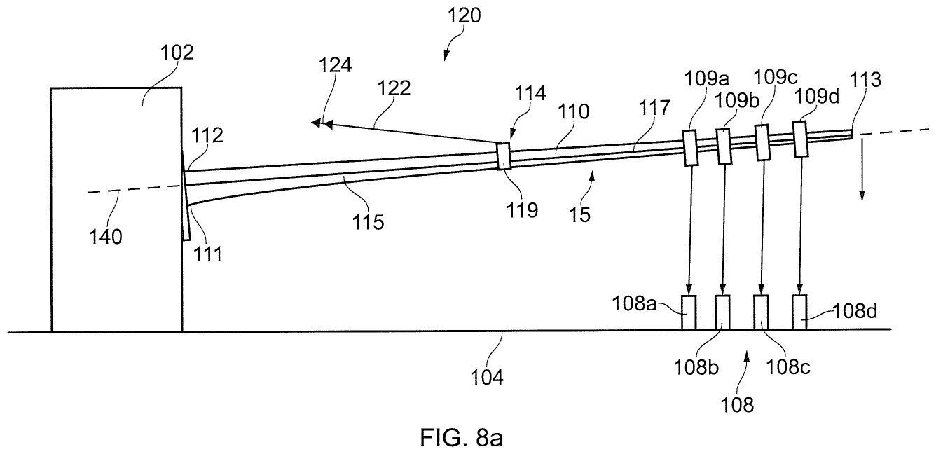

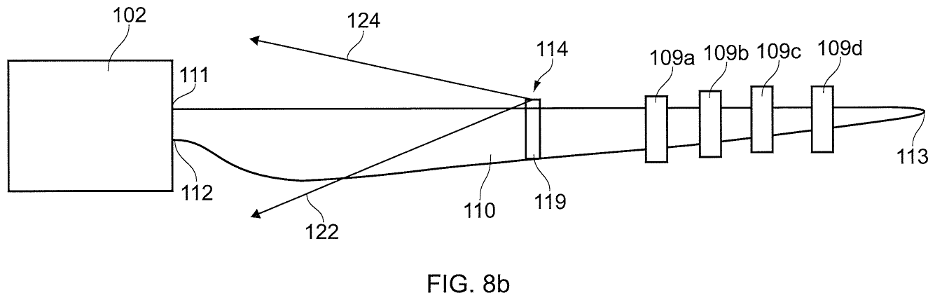

FIGS. 8a and 8b show the wind turbine blade specimen 110 arranged on testing apparatus 100 for a (forward) flatwise static test. FIG. 8a shows a side view and 8b shows a plan view of the setup. In this example, the wind turbine blade specimen 110 is the same as shown in FIGS. 7a and 7b and like reference numerals denote like parts and will not be described again for brevity.

The wind turbine blade specimen 110 may be orientated at a zero pitch angle with the suction side 15 of the wind turbine blade specimen 110 facing towards the ground 104. The wind turbine blade specimen 110 may be upwardly inclined from the root 11.

In FIG. 8a the first actuator 108 is grounded and is configured to apply a distributed load to the wind turbine blade specimen 110. The first load to be applied by the first actuator 108 is generally perpendicular to a neutral axis 140 of the wind turbine blade specimen when viewing in the blade chordwise direction when the tip 113 is at maximum deflection under the maximum of the first load of the static test. A series of blade clamps 109a, 109b, 109c, 109d are secured around the wind turbine blade specimen 110 and couple the first actuator 108 to the wind turbine blade specimen 110. The first actuator 108 comprises a series of grounded winches 108a, 108b, 108c, 108d with cables coupled to the respective blade clamps 109a, 109b, 109c, 109d to pull down on the blade specimen 110 towards the ground 104. The blade clamps 109a, 109b, 109c, 109d may be positioned away from the connector 119 and preferably are positioned around the outboard portion 117 of the wind turbine blade specimen 110. However, the blade clamps or attachment for coupling the first actuator 108 to the wind turbine blade specimen 110 may be provided at any spanwise location along the wind turbine blade specimen 110 away from the root 111.

The first load applied at a first location on the wind turbine blade specimen 110 away from the first end 112 deflects the wind turbine blade specimen 110 towards the ground 104 to mimic the maximum flatwise static design load the wind turbine blade specimen 110 is expected to withstand.

The same set of strain gauges or other measurement devices 130 on the wind turbine blade specimen 110 as described above may be used to measure the load and/or bending moment and/or deflection of the wind turbine blade specimen 110 during the flatwise static test.

Cables 122, 124 may be coupled to the cable connection point 114 on the connector 119 on the opposite side of the blade from the first load and pretensioned to carry tensile load as described above, partially supporting the first load. The first angle alpha (a) and the second angles beta 31 and 12 may be as previously described.

The loading of the wind turbine blade specimen 110 may target a bending moment distribution along the spanwise length of the wind turbine blade specimen 110 from root 112 to tip 113 in the same way as previously described. The cable tension required at the maximum flatwise static test load and corresponding tip deflection position to achieve the target bending moment distribution may be based upon expected flatwise static load data for the wind turbine blade specimen.

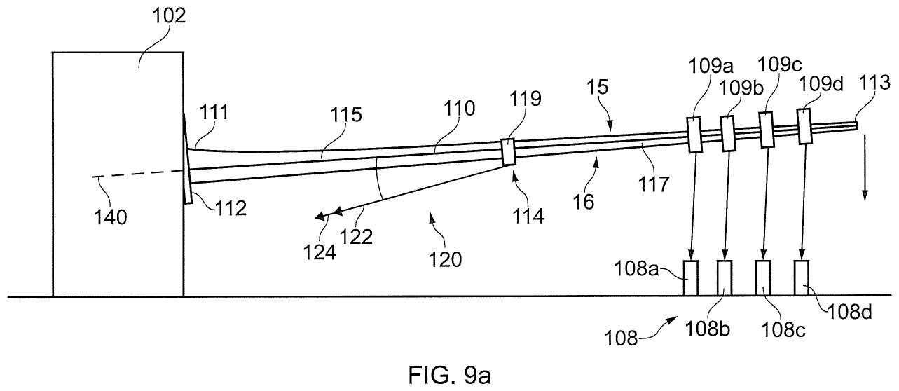

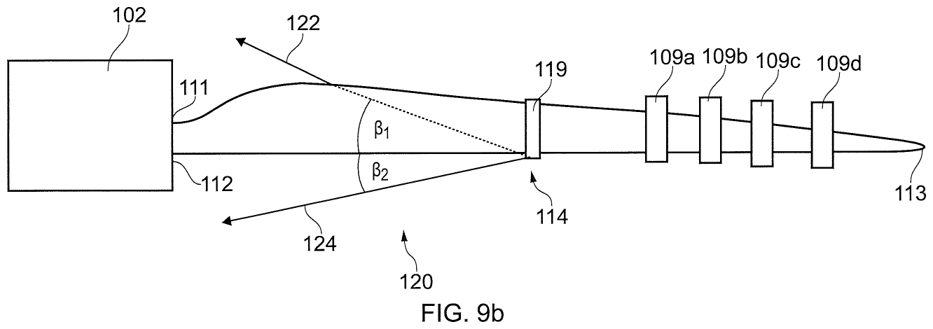

FIGS. 9a and 9b show the wind turbine blade specimen 110 arranged on testing apparatus 100 for a reverse flatwise static test. FIG. 9a shows a side view and 9b shows a plan view of the setup. In this example, the wind turbine blade specimen 110 is the same as shown in FIGS. 7a and 7b and like reference numerals denote like parts and will not be described again for brevity.

The wind turbine blade specimen 110 may be orientated at a 180 degree pitch angle with the pressure side 16 of the wind turbine blade specimen 110 facing towards the ground 104. The wind turbine blade specimen 110 may be upwardly inclined from the root 11. The angle of inclination of the neutral axis to the ground 104 may be less than for the forward flatwise test setup since the loads and hence the deflection of the tip 113 to a minimum clearance from the ground 104 are less.

In FIG. 9a the first actuator 108 is grounded and is configured to apply a distributed load to the wind turbine blade specimen 110 and may have the same setup of a series of grounded winches 108a, 108b, 108c, 108d with cables coupled to respective blade clamps 109a, 109b, 109c, 109d to pull down on the blade specimen 110 towards the ground 104 as described above for the forward flatwise test.

The first load applied at a first location on the wind turbine blade specimen 110 away from the first end 112 deflects the wind turbine blade specimen 110 towards the ground 104 to mimic the maximum reverse flatwise static design load the wind turbine blade specimen 110 is expected to withstand.

The same set of strain gauges or other measurement devices 130 on the wind turbine blade specimen 110 as described above may be used to measure the load and/or bending moment and/or deflection of the wind turbine blade specimen 110 during the reverse flatwise static test.

Cables 122, 124 may be coupled to the cable connection point 114 on the connector 119 and pretensioned to carry tensile load as described above. Since the wind turbine blade specimen is inverted 180 degrees compared to the forward flatwise test setup, the cables 122, 124 extend beneath the wind turbine blade specimen 110. Also, when viewed in the above plan view of FIG. 9b the cable 122 is shown partially in broken line where it is obscured by the blade specimen 110. The first angle alpha (α) and the second angles beta β1 and β2 may be as previously described but the angles may be different compared the forward flatwise setup, e.g. if space constraints between the blade specimen 110 and the ground 104 so dictate. Also, the grounded winches 108a-108d couple to the opposite side of the blade clamps 109a-109d as the blade clamps are inverted with the inverted blade specimen 110.

The loading of the wind turbine blade specimen 110 may target a bending moment distribution along the spanwise length of the wind turbine blade specimen 110 from root 112 to tip 113 in the same way as previously described. The cable tension required at the maximum reverse flatwise static test load and corresponding tip deflection position to achieve the target bending moment distribution may be based upon expected flatwise static load data for the wind turbine blade specimen. In this orientation with the cables on the same side of the blade as the first load, the cables do not provide load relief, as is the case with an operational blade in reverse flatwise loading.

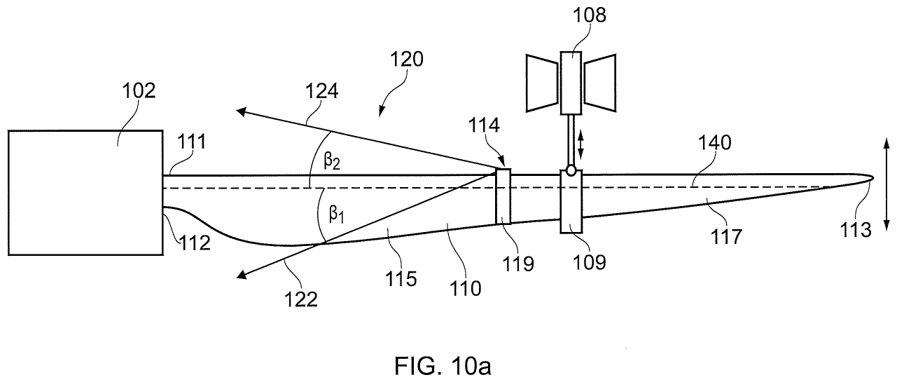

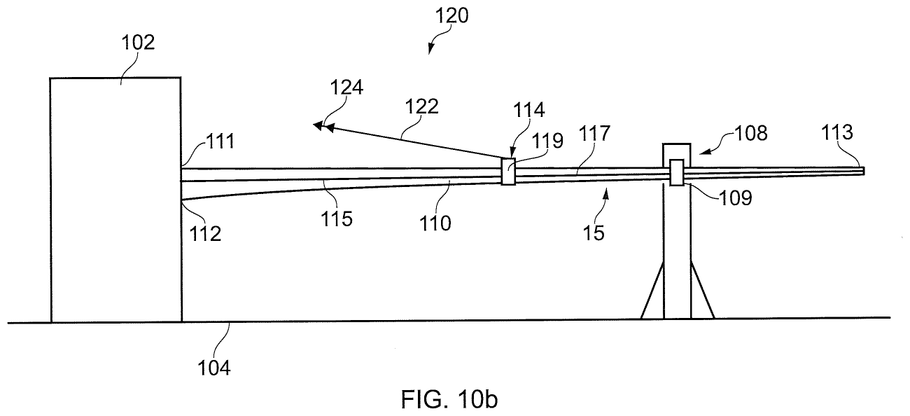

FIGS. 10a and 10b show the wind turbine blade specimen 110 arranged on testing apparatus 100 for an edgewise fatigue test. FIG. 10a shows a plan view and 10b shows a side view of the setup. In this example, the wind turbine blade specimen 110 is the same as shown in FIGS. 7a and 7b and like reference numerals denote like parts and will not be described again for brevity.

To reduce the number of setups of the wind turbine blade specimen 110 to complete all of the tests, in the edgewise fatigue load test the wind turbine blade specimen 110 may be orientated at a zero pitch angle with the suction side 15 of the wind turbine blade specimen 110 facing towards the ground 104. In this example, the wind turbine blade specimen 110 is the same as shown in FIGS. 7a and 7b and like reference numerals denote like parts and will not be described again for brevity. The wind turbine blade specimen 110 may be upwardly inclined from the root 11, although the angle of inclination may be lower than for the flatwise tests described above.

The first load may be a point load, such as by using a grounded linear actuator 108 connected to a blade clamp 109. The first load to be applied by the first actuator 108 is generally perpendicular to the neutral axis 140 of the wind turbine blade specimen when viewing in the blade thickness direction. The first actuator 108 may be a hydraulic actuator that moves linearly in reciprocation to provide an excitation load to the wind turbine blade specimen via the blade clamp 109 so as to oscillate the wind turbine blade specimen to move fore and aft generally parallel to the chord of the wind turbine blade specimen 110.

The blade clamp 109 may be positioned away from the connector 119 and preferably is positioned around the inboard portion 115 of the wind turbine blade specimen 110. However, the blade clamp 109 or attachment for coupling the first actuator 108 to the wind turbine blade specimen 110 may be provided at any spanwise location along the wind turbine blade specimen 110 away from the root 111, e.g. on the outboard portion 117 of the blade specimen as shown in FIGS. 10a and 10b.

The first load excites the wind turbine blade specimen 110 to oscillate at a natural frequency of the wind turbine blade specimen to deflect the cantilevered free end of the wind turbine blade specimen aft generally parallel to the chord of the wind turbine blade specimen 110 to mimic the sum of dynamic cycles of varying magnitude the production blade may be expected to experience in its lifetime.

The same set of strain gauges or other measurement devices 130 on the wind turbine blade specimen 110 as described above may be used to measure the load and/or bending moment and/or deflection of the wind turbine blade specimen 110 during the edgewise fatigue test.

Cables 122, 124 may be coupled to the cable connection point 114 on the connector 119 and pretensioned to carry tensile load as described above. The first angle alpha (α) and the second angles beta β1 and β2 may be as previously described. In the edgewise fatigue test with the blade specimen at zero pitch the first angles (α) that the cables 122, 124 make with the blade specimen do not significantly change as the blade specimen 110 moves fore and aft. However, the second angles beta (β1, β2) of the cables 122, 124 will change as the blade specimen oscillates fore and aft. The tensile load in the cables 122, 124 which extend away from the pressure side 16 of the blade specimen in the edgewise fatigue test act against gravity. The loads due to gravity are therefore also taken into account when calculating the blade specimen test setup to achieve the target bending moment distribution for the blade specimen.

The tensile load in the cables 122, 124 may be varied according to the tip deflection position of the blade specimen 110. This variable tensile load is preferable due to the changing second angles beta (β1, β2) that the cables 122, 124 make with the neutral axis 140 of the blade. In the edgewise fatigue test of FIGS. 10a and 10b the variable cable tension may be selected to provide the target bending moment distribution as the blade specimen oscillates fore and aft through a range of tip deflection positions. The cable tension required at each tip deflection position to achieve the target bending moment distribution may be based upon expected edgewise static load data, a subset of which may be used in the edgewise (and reverse edgewise) static load testing, the setup of which will now be described.

The cables 122, 124 provide partial support of the load, cable 124 providing support as the blade is driven in the stroke away from actuator 108 and cable 122 in the opposite sense.

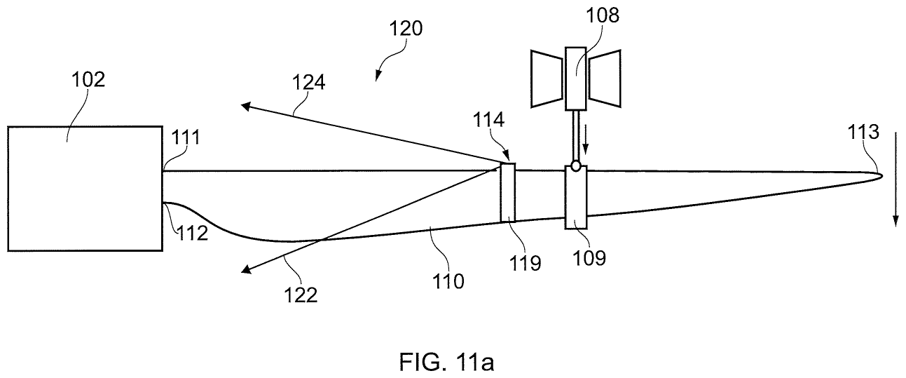

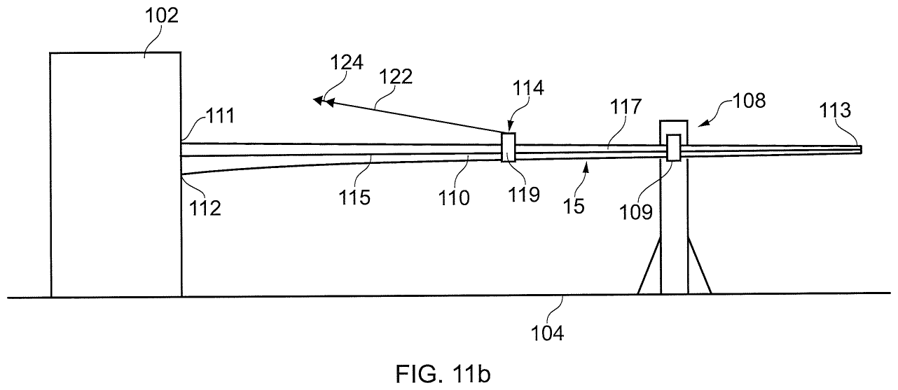

FIGS. 11a and 11b show the wind turbine blade specimen 110 arranged on testing apparatus 100 for a (forward) edgewise static test. FIG. 11a shows a plan view and 11b shows a side view of the setup. In this example, the wind turbine blade specimen 110 is the same as shown in FIGS. 10a and 10b and like reference numerals denote like parts and will not be described again for brevity.

The wind turbine blade specimen 110 may be orientated at a zero pitch angle with the suction side 15 of the wind turbine blade specimen 110 facing towards the ground 104. The wind turbine blade specimen 110 may be upwardly inclined from the root 11.

The first actuator 108 may be the same as used in the edgewise fatigue test and coupled to the blade by the same blade clamp 109 as described previously with reference to FIGS. 10a and 10b.

The first load may be a point load, such as by using a grounded linear actuator connected to a blade clamp. The first load applied by the first actuator 108 at a first location on the wind turbine blade specimen 110 away from the first end 112 deflects the cantilevered free end of the wind turbine blade specimen aft generally parallel to the chord of the wind turbine blade specimen 110 to mimic the maximum edgewise static design load the wind turbine blade specimen 110 is expected to withstand.

The same set of strain gauges or other measurement devices 130 on the wind turbine blade specimen 110 as described above may be used to measure the load and/or bending moment and/or deflection of the wind turbine blade specimen 110 during the (forward) edgewise static test.

Cables 122, 124 may be coupled to the cable connection point 114 on the connector 119 and pretensioned to carry tensile load as described above. The first angle alpha (α) and the second angles beta β1 and β2 may be as previously described for the edgewise fatigue test. The tensile load in the cables 122, 124 may be varied according to the tip deflection position of the blade specimen 110. This variable tensile load is preferable due to the changing second angles beta β1 and β2 that the cables 122, 124 make with the neutral axis 140 of the blade. In the (forward) edgewise static test of FIGS. 11a and 11b the variable cable tension may be selected to provide the target bending moment distribution as the blade specimen deflects aft through a range of tip deflection positions. The cable tension required at each tip deflection position to achieve the target bending moment distribution may be based upon expected edgewise static load data. In this case cable 124 provides partial load support, mimicking the load support provided in an operational blade.

The loading of the wind turbine blade specimen 110 may target a bending moment distribution along the spanwise length of the wind turbine blade specimen 110 from root 112 to tip 113 in the same way as previously described. The cable tension required at the maximum (forward) edgewise static test load and corresponding tip deflection position to achieve the target bending moment distribution may be based upon expected edgewise static load data for the wind turbine blade specimen.

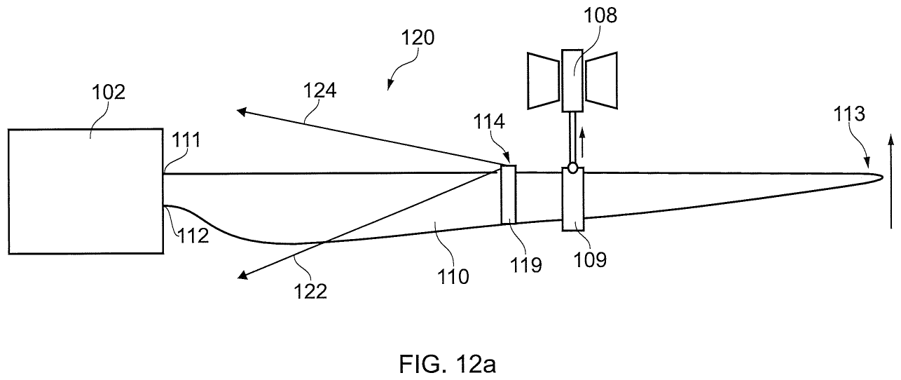

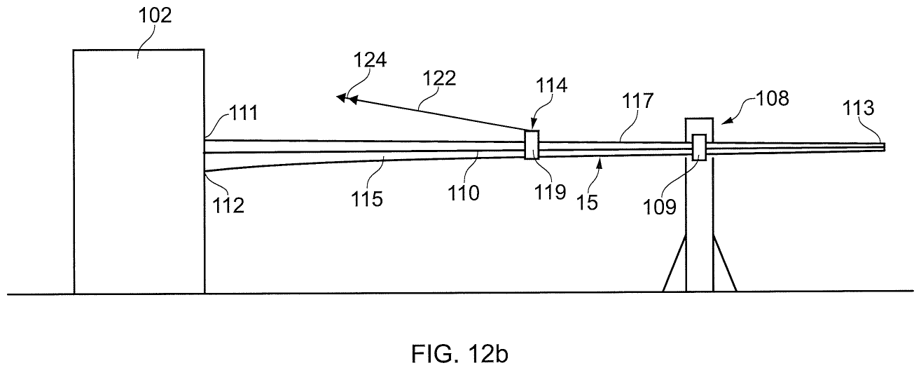

FIGS. 12a and 12b show the wind turbine blade specimen 110 arranged on testing apparatus 100 for a reverse edgewise static test. FIG. 12a shows a plan view and 12b shows a side view of the setup. In this example, the wind turbine blade specimen 110 is the same as shown in FIGS. 10a and 10b and like reference numerals denote like parts and will not be described again for brevity.

The wind turbine blade specimen 110 may be orientated at a zero pitch angle with the suction side 15 of the wind turbine blade specimen 110 facing towards the ground 104. The wind turbine blade specimen 110 may be upwardly inclined from the root 11.

The first load may be a point load, such as by using a grounded linear actuator connected to a blade clamp. The first actuator 108 may be the same as used in the edgewise fatigue test and coupled to the blade by the same blade clamp 109 as described previously with reference to FIGS. 10a and 10b.

The first load applied by the first actuator 108 at a first location on the wind turbine blade specimen 110 away from the first end 112 deflects the cantilevered free end of the wind turbine blade specimen forward generally parallel to the chord of the wind turbine blade specimen 110 to mimic the maximum reverse edgewise static design load the wind turbine blade specimen 110 is expected to withstand.

The same set of strain gauges or other measurement devices 130 on the wind turbine blade specimen 110 as described above may be used to measure the load and/or bending moment and/or deflection of the wind turbine blade specimen 110 during the reverse edgewise static test.

Cables 122, 124 may be coupled to the cable connection point 114 on the connector 119 and pretensioned to carry tensile load as described above. The first angle alpha (α) and the second angles beta β1 and β2 may be as previously described for the edgewise fatigue test. The tensile load in the cables 122, 124 may be varied according to the tip deflection position of the blade specimen 110. This variable tensile load is preferable due to the changing second angles beta β1 and β2 that the cables 122, 124 make with the neutral axis 140 of the blade. In the reverse edgewise static test of FIGS. 12a and 12b the variable cable tension may be selected to provide the target bending moment distribution as the blade specimen deflects forward through a range of tip deflection positions. The cable tension required at each tip deflection position to achieve the target bending moment distribution may be based upon edgewise static load predicted data.

The loading of the wind turbine blade specimen 110 may target a bending moment distribution along the spanwise length of the wind turbine blade specimen 110 from root 112 to tip 113 in the same way as previously described. The cable tension required at the maximum reverse edgewise static test load and corresponding tip deflection position to achieve the target bending moment distribution may be based upon expected edgewise static load data for the wind turbine blade specimen. In this case cable 122 provides partial load support, mimicking the load support provided in an operational blade.

The load assembly 120 applies a tension in the cables 122, 124 as mentioned above. The load assembly 120 may further comprise at least one cable actuator 125, 126. Each cable actuator 125, 126 may be coupled to a respective one of the cables 122, 124 for applying a tensile load in the cable. The cable actuator 125, 126 may be a hydraulic actuator. The cable actuator 125, 126 may be actively or passively controllable.

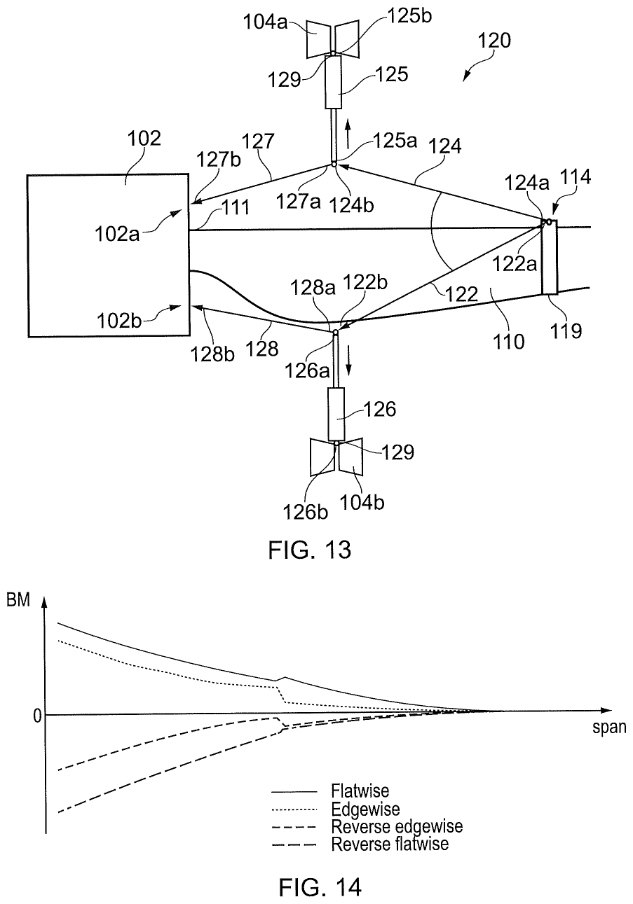

FIG. 13 illustrates a first arrangement of the load assembly 120 in which first ends 124a, 124b of the cables 122, 124 are coupled to the cable connection point 114 on the blade specimen 110, and the cables 122, 124 are each denoted as first cables. The first cables 122, 124 are on the blade side of the load assembly 120. The load assembly further comprises second additional cable 127 and cable actuator 125 coupled to first cable 124, and second additional cable 128 and cable actuator 126 coupled to first cable 122. The second additional cables 127 and 128 are on the ground side of the load assembly and are grounded.

The second cables 127, 128 have respective first ends 127a, 128a and second ends 127b, 128b. The cable actuators 125, 126 have respective first ends 125a, 126a and second ends 126a, 126b.

The second end 124b of first cable 124 and the first end 127a of second cable 127 are coupled to the first end 125a of cable actuator 125. The second end 127b of the second cable 127 is coupled to a first fixation point 102a. The second end 125b of the cable actuator 125 is coupled to a second fixation point 104a.

The second end 122b of first cable 122 and the first end 128a of second cable 128 are coupled to the first end 126a of cable actuator 126. The second end 128b of the second cable 128 is coupled to a first fixation point 102b. The second end 126b of the cable actuator 126 is coupled to a second fixation point 104b.

The first and second fixation points 102a, 102b, 104a, 104b are each substantially rigidly fixed with respect to the first support 102. The first fixation point 102a may be on the first support 102 (which may be fixed directly to the ground 104) or may be grounded in some other way. The second fixation point 104a may be fixed directly to the ground 104 or may be grounded in some other way. The first fixation point 102b may be on the first support 102 (which may be fixed directly to the ground 104) or may be grounded in some other way. The second fixation point 104b may be fixed directly to the ground 104 or may be grounded in some other way.

The first and second ends 125a, 125b, 126a, 126b of the cable actuators 125, 126 may have freedom of movement. This enables the cable actuators 125, 126 to move through a range of angles and positions as the first cables 122, 124 deflect with the deflection of the blade specimen 110.

The second ends 125b, 126b of the cable actuators 125, 126 may be coupled to the second fixation points 104a, 104b by an adjustable connection 129. The adjustable connection 129 may include a screw threaded adjuster to allow initial slack in the first cables 122, 124 and second cables 127, 128 to be taken up prior to tensioning the cables with the cable actuators 125, 126. This may allow for slack in the cables while setting up the test apparatus but also reduce the required stroke of the cable actuator, e.g. to ensure no cable slack arises during fatigue testing which could otherwise result in high loads as the slack cable becomes taught.

The cable actuators 125, 126 may be passively controlled during the test of the wind turbine blade specimen 110. The cable actuators 125, 126 may be configured to apply a predetermined tensile load in the cable prior to commencement of the test. The cable actuators 125, 126 may be moved (retracted in the arrangement shown in FIG. 13) to apply the predetermined tensile load. For example, where the cable actuators 125, 126 are hydraulic actuators then a pre-charged accumulator coupled to the hydraulic actuators may be used to retract the cable actuator to the pre-load position. As the cable actuator retracts, the angle of the first cables 122, 124 moves to a desired angle (both alpha and beta angles) extending from the cable connection point 114. The desired angle of the cables 122, 124 may correspond to a desired cable angle at the maximum blade specimen loading deflection (for static test) or mean blade specimen loading deflection (for fatigue test) of the wind turbine blade specimen 110 and the desired cable tension for relieving load on the blade specimen to achieve the desired bending moment distribution along the blade specimen. The pre-charged accumulator may provide an approximately linear response as the blade specimen deflects.

The load assembly 120 shown in FIG. 13 may be used with any of the fatigue or static tests described above. Where the load assembly 120 is used with the blade specimen in the 180 degree pitch position, such as in the set up shown in FIG. 9 a, then the only difference compared to when used with the blade in the zero degree pitch position, such as in the set up shown in FIG. 7a, is that the cable actuators 125, 126 are position closer to the ground 104. This may require a second fixation points 104a, 104b to be closer to the ground or the use of second fixation points with variable height adjustment for positioning the cable actuator at different heights from the ground.

FIG. 14 shows typical bending moment distribution plots for the different static load cases. The blade span position is shown on the x axis and the bending moment value is shown on the y axis. The four plots show the (forward) flatwise, (forward) edgewise, reverse edgewise and reverse flatwise bending moment distribution plots expected for an entire wind turbine blade with one or more load relieving blade connecting members coupled at approximately 50% of the blade span. The expected bending moment distribution plots may be derived from computational models of a production wind turbine rotor. These expected computational bending moment distributions may be used as the target bending moment distributions to be achieved by the test setups for the static and fatigue tests described above. Notably, the expected bending moment distribution plots each show a step change in the bending moment value in the vicinity of the load relieving blade connecting members and a change of slope in the bending moment distribution either side of the step due to the loads relief provided by the blade connecting members 6 of the operational wind turbine blade 5. This change of slope is the expected reduction in bending moment due to the loads relief provided by the one or more load relieving blade connecting members, where the blade connecting members support a portion of the blade loads that would otherwise need to be supported by the blade inboard of the connection to the blade connecting members. The slope has a reduced gradient just inboard of the cable connection point compared to the slope just outboard of the cable connection point in the blade spanwise direction. The step change in the bending moment distribution is due to the offset between the cable connection point and the blade neutral axis, which offset causes a moment to be applied at that point. Where the cable forms an acute angle with the neutral axis there is an additional benefit of the relieving load as a sin of the cable angle which increases linearly with the increase in lever arm towards the root end of the blade.

The target bending moment distributions to be used in the blade specimen testing derived from these computations are achieved by the first load applied by the first actuator 108 in combination with the loads relief provided by the loads assembly 120.

As described above, the cable actuators 125, 126 in the arrangement of the loads assembly 120 in FIG. 13 may be passive actuators. Alternatively, the cable actuators 125, 126 in the arrangement of the loads assembly 120 in FIG. 13 may be active actuators. The active actuators may be controlled by force or displacement feedback. For example, the actuator force or actuator displacement may be controlled depending on the load in the cables 122, 124 or of the blade specimen, or may be controlled depending on the displacement of the cables 122, 124 or of the blade specimen 110. Passive cable actuators may have the benefit of predictable loads whereas active actuators may suffer problems of unexpected loading, which would need to be mitigated, e.g. by control schemes.

The loads assembly 120 in FIG. 13 may be configured to apply a tensile load in the cables 122, 124 which varies with displacement of the cables 122, 124, e.g. a substantially linear response. With the cable actuators 125, 126 being passive, the displacement of the blade specimen 110 causes displacement of the cables 122, 124 which causes a change in angle that the cables 122 124 make with the cable actuators. This displacement therefore causes a variable tensile load in the cables 122, 124. Of course, with an active cable actuator setup the loads assembly 120 may be configured to apply a tensile load in the cables 122, 124 which varies with displacement of the cables 122, 124 and this variable load may be decoupled from the cable/actuator geometry.

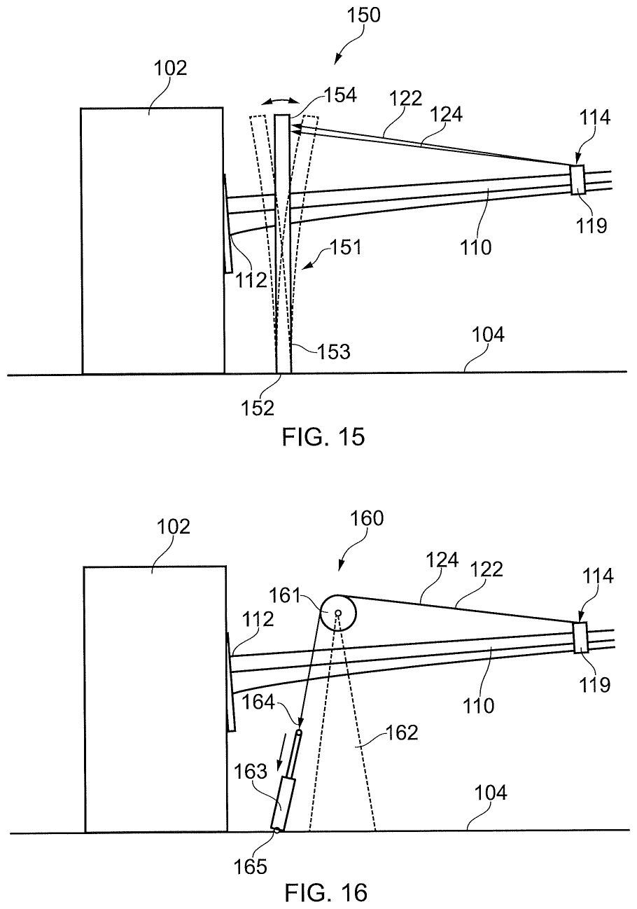

FIG. 15 through to 22 shows various alternative loads assemblies 150, 160, 170, 180, 190, 210, 230, 240 that may be used to apply tension to the cables 122, 124 in any of the test arrangements described above. In these figures, like reference numerals have been used to denote like parts with the testing apparatus 100 arrangements described above and will not be described again here for brevity. It should be noted that the figures are cropped and do not show the tip end of the blade specimen 110 or the first actuator arrangements but these may be the same as in any of FIGS. 7a to 12b described above.

In FIG. 15, the loads assembly 150 comprises a resilient arch 151 coupled to the cables 122, 124. The resilient arch 151 may be made of carbon fibre or other high tensile material. The resilient arch is fixed with respect to the ground 151 at the base 152 of two legs 153 and has a top 154 which extends over or under the blade specimen 110, depending on the test, e.g. whether the test is conducted at a zero degree or 180 degree pitch orientation. The base 152 is fixed with respect to the first support 102. The cables 122, 124 are the same as previously described and are coupled to the top 154 of the resilient arch 151. The cables 122, 124 may be coupled to the top 154 of the arch by an adjustable connection (not shown) that enables slack in the cables to be taken up and a pre-tension applied to the cables 122, 124 prior to commencing testing of the blade specimen 110.

As the blade specimen 110 deflects up and down or fore and aft during the various static and fatigue tests as previously described, the cables 122, 124 will be caused to deflect and this causes deflection of the top 154 of the resilient arch 151 as shown in broken lines in FIG. 15 with respect to the base 152 of the legs 153. It will be appreciated that the resilient arch may deflect in the spanwise and/or chordwise directions of the blade specimen. The resilient arch 151 therefore applies a tensile load in the cables 122, 124 as the blade specimen deflects. Depending on the orientation of the cables 122, 124 and the geometry of the resilient arch 151, the tensile load in the cables 122, 124 may vary with the deflection of the cables 122, 124, or the resilient arch 151 may alternatively apply a predetermined tensile load in the cables 122, 124.

In FIG. 16, the loads assembly 160 comprises pulley wheels 161 rotatably mounted on a grounded support frame 162 and cable actuators 163 respectively coupled to the cables 122, 124. The support frame 162 is fixed with respect to the first support 102. The cables 122, 124 run over the respective pulley wheels 161 located either side of the blade specimen and either above or below the blade specimen 110, depending on the test, e.g. whether the test is conducted at a zero degree or 180 degree pitch orientation.

The cable actuators 163 have a first end 164 coupled to the respective cable 122 or 124, and a second end 165 coupled to the ground 104. Due to the pulley 161, the cable actuators 163 do not need to move through a changing angle as the first cables 122, 124 deflect with the deflection of the blade specimen 110. The first and second ends 164, 165 of the cable actuators 163 may have freedom of movement but this may aid setup of the test apparatus only and may not be required during the test. The first and/or second ends 164, 165 of the cable actuators 163 may have an adjustable connection (not shown) to allow initial slack in the cables 122, 124 to be taken up prior to tensioning the cables with the cable actuators 163. This may allow for slack in the cables while setting up the test apparatus but also reduce the required stroke of the cable actuator.

The cable actuators 163 may be passively controlled during the test of the wind turbine blade specimen 110. The cable actuators 163 may be configured to apply a predetermined tensile load in the cable prior to commencement of the test. The cable actuators 163 may be moved (retracted in the arrangement shown in FIG. 16) to apply the predetermined tensile load. For example, where the cable actuators 163 are hydraulic actuators then a pre-charged accumulator coupled to the hydraulic actuators may be used to retract the cable actuator to the pre-load position. Alternatively, the cable actuators may be actively controlled. The active actuators may be controlled by force or displacement feedback. For example, the actuator force or actuator displacement may be controlled depending on the load in the cables 122, 124 or of the blade specimen, or may be controlled depending on the displacement of the cables 122, 124 or of the blade specimen 110.

As the blade specimen 110 deflects up and down or fore and aft during the various static and fatigue tests as previously described, the cables 122, 124 will be caused to deflect and this causes the ends of the cables 122, 124 at their connection to the first ends 164 of the cable actuators 163 to move. This movement causes the hydraulic cylinder of the cable actuator to retract and extend against the fluid pressure of the hydraulic cylinder which applies the tensile load to the cables 122, 124 as the blade specimen deflects. Depending on the set up of the cable actuators 163, the tensile load in the cables 122, 124 may vary with the deflection of the cables 122, 124, or may alternatively apply a predetermined tensile load in the cables 122, 124.

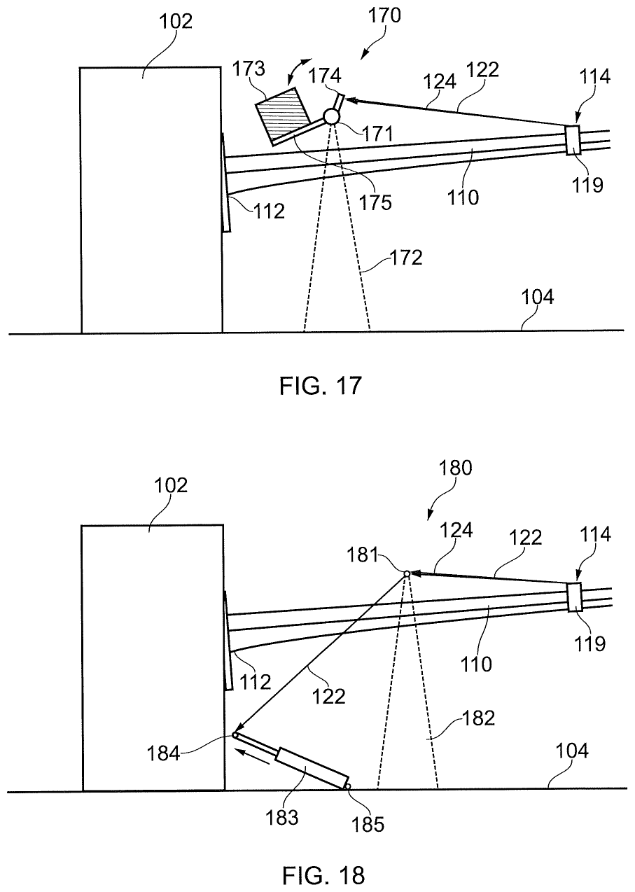

In FIG. 17, the loads assembly 170 comprises a cam mounted to a rotatable shaft, wherein the cam is connected to one end of the at least one cable 122, 124, and the shaft is coupled to a mass 173 to form a pendulum arrangement to react load in the cable. The cam may be in the form of a first portion 174 of a pivoting platform 171 and the mass 173 may be coupled to a second portion 175 of the pivoting platform.

The weighted pivoting platform 171 is pivotably coupled to a grounded support frame 172. The support frame 172 is fixed with respect to the first support 102. The pivoting platform 171 has a first portion 174 extending from the pivot location, the end of which is coupled to the cables 122, 124. The pivoting platform 171 has a second portion 175 extending from the pivot location on the opposite side to the first portion 174 and may form an angle with the first portion 174, for example an obtuse angle between around 130 to 170 degrees. The end of the second portion carries a mass 173. The mass applies a pre-load to tension the cables 122, 124 due to gravity. The pivot location may be positioned above or below the blade specimen 110, depending on the test, e.g. whether the test is conducted at a zero degree of 180 degree pitch orientation.

As the blade specimen 110 deflects up and down or fore and aft during the various static and fatigue tests as previously described, the cables 122, 124 will be caused to deflect and this causes the ends of the cables 122, 124 at their connection to the end of the first portion 174 of the pivoting platform 171 to move, which in turn causes the mass on the end of the second portion 175 of the pivoting platform 171 to move. Through relatively small angular rotations of the pivoting platform, the weight of the mass 173 applies a substantially constant tension in the cables 122, 124. Through larger angular deflections, the weight of the mass 173 may cause a variable tension in the cables 122, 124 as a sine function of the weight of the mass, as the cable deflects during deflection of the blade specimen 110.

The loads assembly 170 has benefits in that the tensile load applied to the cables 122, 124 is achieved solely mechanically and therefore cost and setup time may be reduced. The mass 173 or lever arm of the mass from the pivot location may be adjustable prior to each test to tailor the tensile load applied to the cables 122, 124. The lateral position of coupling the cable 122 or 124 to the pivoting platform 171 may also be adjusted to alter the angle beta of the cables.

In FIG. 18, the loads assembly 180 comprises a grounded support frame 182 having an apex 181 over which the cables 122, 124 pass, and one or more cable actuators 183. The apex 181 may be positioned above or below the blade specimen 110, depending on the test, e.g. whether the test is conducted at a zero degree or 180 degree pitch orientation. The apex may be a smooth rod, for example, enabling substantially friction free traversing of the cables 122, 124 over the apex 181.

The cable actuators 183 have a first end 184 coupled to the respective cable 122 or 124, and a second end 185 coupled to the ground 104. Due to the apex 181, the cable actuators 183 do not need to move through a changing angle as the first cables 122, 124 deflect with the deflection of the blade specimen 110. The first ends 184, 185 of the cable actuators 183 may have freedom of movement. The first and/or second ends 184, 185 of the cable actuators 183 may have an adjustable connection (not shown) to allow initial slack in the cables 122, 124 to be taken up prior to tensioning the cables with the cable actuators 183. This may allow for slack in the cables while setting up the test apparatus but also reduce the required stroke of the cable actuator. The axis of the linear cable actuators 183 may form an acute angle with their respective cable 122, 124. The cable loads are therefore reacted into the ground 104 and not into the first support 102. This may distribute the ground loads of the test apparatus more effectively to avoid stress concentrations.

The cable actuators 183 may be passively controlled during the test of the wind turbine blade specimen 110. The cable actuators 183 may be configured to apply a predetermined tensile load in the cable 122, 124 prior to commencement of the test. The cable actuators 183 may be moved (extended in the arrangement shown in FIG. 18) to apply the predetermined tensile load. For example, where the cable actuators 183 are hydraulic actuators then a pre-charged accumulator coupled to the hydraulic actuators may be used to extend the cable actuator to the pre-load position. Alternatively, the cable actuators may be actively controlled. The active actuators may be controlled by force or displacement feedback. For example, the actuator force or actuator displacement may be controlled depending on the load in the cables 122, 124 or of the blade specimen, or may be controlled depending on the displacement of the cables 122, 124 or of the blade specimen 110.

As the blade specimen 110 deflects up and down or fore and aft during the various static and fatigue tests as previously described, the cables 122, 124 will be caused to deflect and this causes the ends of the cables 122, 124 at their connection to the first ends 184 of the cable actuators 183 to move. This movement causes the hydraulic cylinder of the cable actuator to retract and extend against the fluid pressure of the hydraulic cylinder which applies the tensile load to the cables 122, 124 as the blade specimen deflects. Depending on the set up of the cable actuators 183, the tensile load in the cables 122, 124 may vary with the deflection of the cables 122, 124, or may alternatively apply a predetermined tensile load in the cables 122, 124.

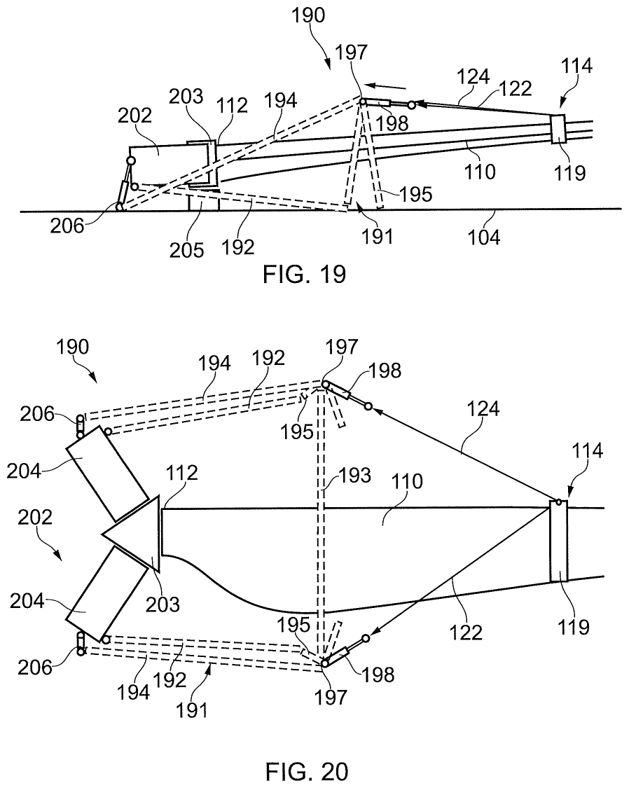

FIGS. 19 and 20 show side and plan views respectively of loads assembly 190 and of an alternative first support 202 holding the blade specimen 110. The alternative first support comprises a hub portion 203 to mimic the hub 4 of the production wind turbine rotor, and a pair of reaction arms 204. The reaction arms 204 are short cylindrical sections, e.g. made of steel, coupled to the hub portion 203. The blade specimen 110 coupled to a hub/blade interface of the hub portion 204. The reaction arms 204 allow the load from the blade specimen 110 to go through the hub portion 203 and be reacted at two points behind. Each of the reaction arms 204 and the blade specimen 110 may form an angle of around 120 degrees. The hub portion 203 is pivotally mounted to the ground 104 by pivot support base 205. A pair of actuators 206 are coupled between the ground 104 and the respective reaction arms 204 for articulating the blade specimen 110 about the pivot support base 205. The ends of the reaction arms 204 nearest the actuators 206 have a surface which can bear onto a stall. The actuators 206 can pull down on the reaction arms 204 so that the reaction arm surface bears on the stall to set the angle of inclination of the blade specimen 110. The stall can be one of a set of different height stalls for adjusting the blade angle of inclination. The blade specimen 110 is adjustable in pitch at the hub/blade interface at the first end 112 of the blade specimen 110. For example, the blade specimen 110 may be fitted in one of a plurality of different pitch positions at the hub/blade interface.

The loads assembly 190 comprises a support frame 191 which comprises several frame elements 192, 193, 194, 195. First frame elements 194 are respectively connected between the ground connection at the base of the actuator 206 and the top of an A-frame 195 situated on either side of the blade specimen. The A-frame 195 is grounded. Second frame elements 193 extends between the top of the A-frames 195 over the blade specimen 110. Third frame elements 192 respectively extend between the reaction arms 204 and the base of the A-frames 195. The third frame elements 192 are extendable to accommodate the articulation of the first support 202 about the pivot support base 205 to vary the inclination of the neutral axis of the blade specimen 110 relative to the ground 104 prior to commencing the blade test.

The apex 197 of each of the A-frames 195 is coupled to a first end of a cable actuator 198, an opposite second end of each cable actuator 198 being coupled to the respective cable 122, 124. The first and/or second ends of the cable actuators 198 may have freedom of movement. The first and/or second ends of the cable actuators 198 may have an adjustable connection (not shown) to allow initial slack in the cables 122, 124 to be taken up prior to tensioning the cables with the cable actuators 198. This may allow for slack in the cables while setting up the test apparatus but also reduce the required stroke of the cable actuator. The axis of the linear cable actuators 198 may form a straight line with their respective cable 122, 124. The cable loads are therefore reacted into the ground 104 and into the first support 102. This may distribute the ground loads of the test apparatus more effectively to avoid stress concentrations.

The cable actuators 198 may be passively controlled during the test of the wind turbine blade specimen 110. The cable actuators 198 may be configured to apply a predetermined tensile load in the cable 122, 124 prior to commencement of the test. The cable actuators 198 may be moved (retracted in the arrangement shown in FIGS. 19 and 20) to apply the predetermined tensile load. For example, where the cable actuators 198 are hydraulic actuators then a pre-charged accumulator coupled to the hydraulic actuators may be used to extend the cable actuator to the pre-load position. Alternatively, the cable actuators may be actively controlled. The active actuators may be controlled by force or displacement feedback. For example, the actuator force or actuator displacement may be controlled depending on the load in the cables 122, 124 or of the blade specimen, or may be controlled depending on the displacement of the cables 122, 124 or of the blade specimen 110.

As the blade specimen 110 deflects up and down or fore and aft during the various static and fatigue tests as previously described, the cables 122, 124 will be caused to deflect and this causes the ends of the cables 122, 124 at their connection to the cable actuators 198 to move. This movement causes the hydraulic cylinder of the cable actuator to retract and extend against the fluid pressure of the hydraulic cylinder which applies the tensile load to the cables 122, 124 as the blade specimen deflects. Depending on the set up of the cable actuators 198, the tensile load in the cables 122, 124 may vary with the deflection of the cables 122, 124, or may alternatively apply a predetermined tensile load in the cables 122, 124.

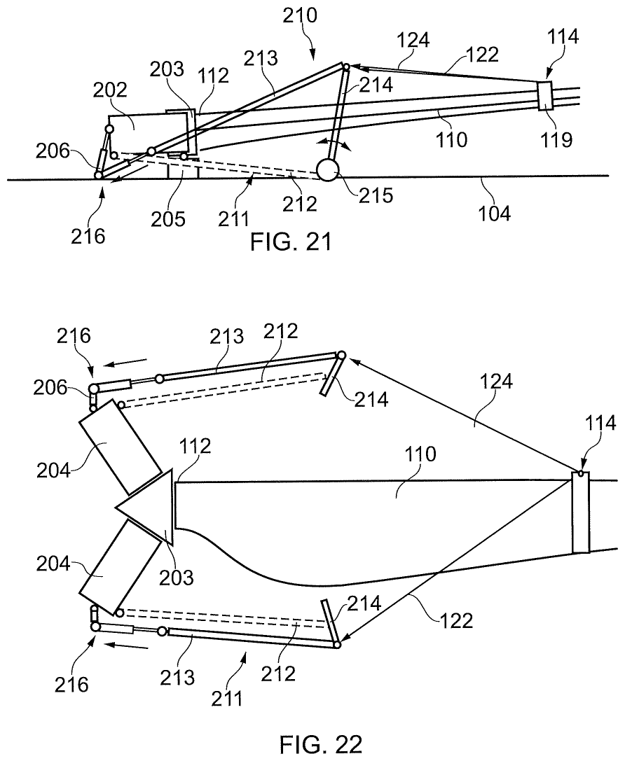

FIGS. 21 and 22 show side and plan views respectively of loads assembly 210 to be used with the alternative first support 202 holding the blade specimen 110. The alternative first support 202 is the same as described above with reference to FIGS. 19 and 20 and so will not be described further here.

The loads assembly 210 comprises a support frame 211 which comprises several frame elements 212, 213, 214. First frame elements 212 are respectively connected between the reaction arms 204 and a frame pivot base 215. Second frame elements 214 are pivotally mounted to the frame pivot base 215 at a lower end of each second frame element 214 and to the ends of cables 122, 124 at an upper end of each second frame element 214. First frame elements 212 may be elastic elements and/or are extendable to accommodate the articulation of the first support 202 about the pivot support base 205 to vary the inclination of the neutral axis of the blade specimen 110 relative to the ground 104 prior to commencing the blade test. Third frame elements 213 are connected between the ends of cables 122, 124 and respective cable actuators 216.

The first and/or second ends of the cable actuators 216 may have freedom of movement. The first and/or second ends of the cable actuators 216 may have an adjustable connection (not shown) to allow initial slack in the cables 122, 124 to be taken up prior to tensioning the cables with the cable actuators 216. This may allow for slack in the cables while setting up the test apparatus but also reduce the required stroke of the cable actuator. The axis of the linear cable actuators 216 may form a straight line with their respective third frame elements 213. The cable loads are therefore reacted into the ground 104 and into the first support 102. This may distribute the ground loads of the test apparatus more effectively to avoid stress concentrations.

The cable actuators 216 may be passively controlled during the test of the wind turbine blade specimen 110. The cable actuators 216 may be configured to apply a predetermined tensile load in the cable 122, 124 prior to commencement of the test. The cable actuators 216 may be moved (retracted in the arrangement shown in FIGS. 21 and 22) to apply the predetermined tensile load. For example, where the cable actuators 216 are hydraulic actuators then a pre-charged accumulator coupled to the hydraulic actuators may be used to extend the cable actuator to the pre-load position. Alternatively, the cable actuators may be actively controlled. The active actuators may be controlled by force or displacement feedback. For example, the actuator force or actuator displacement may be controlled depending on the load in the cables 122, 124 or of the blade specimen, or may be controlled depending on the displacement of the cables 122, 124 or of the blade specimen 110.

As the blade specimen 110 deflects up and down or fore and aft during the various static and fatigue tests as previously described, the cables 122, 124 will be caused to deflect and this causes the ends of the cables 122, 124 at their connection to the upper ends of the second frame elements 214 to move. This movement causes the second frame elements 214 to articulate about the frame pivot base 215 and also causes the third frame elements 213 to move which causes the hydraulic cylinder of the cable actuator to retract and extend against the fluid pressure of the hydraulic cylinder which applies the tensile load to the cables 122, 124 as the blade specimen deflects. Depending on the set up of the cable actuators 216, the tensile load in the cables 122, 124 may vary with the deflection of the cables 122, 124, or may alternatively apply a predetermined tensile load in the cables 122, 124.

In any of the above described examples, the cable actuators may be ram actuators or the actuators may be replaced by springs. The spring or ram actuator is extensible to react load in the cable.

In any of the above described examples, the wind turbine blade specimen may be a portion of a segmented wind turbine blade. The segmented wind turbine blade may have an inboard blade portion and an outboard blade portion connected to each other at a split position. The inboard blade portion and outboard blade portion may be connected by a connection joint. The connection joint may include a connector connected to an end surface of the inboard blade portion and to an end surface of the outboard blade portion. The cable connection point may be on the connector.

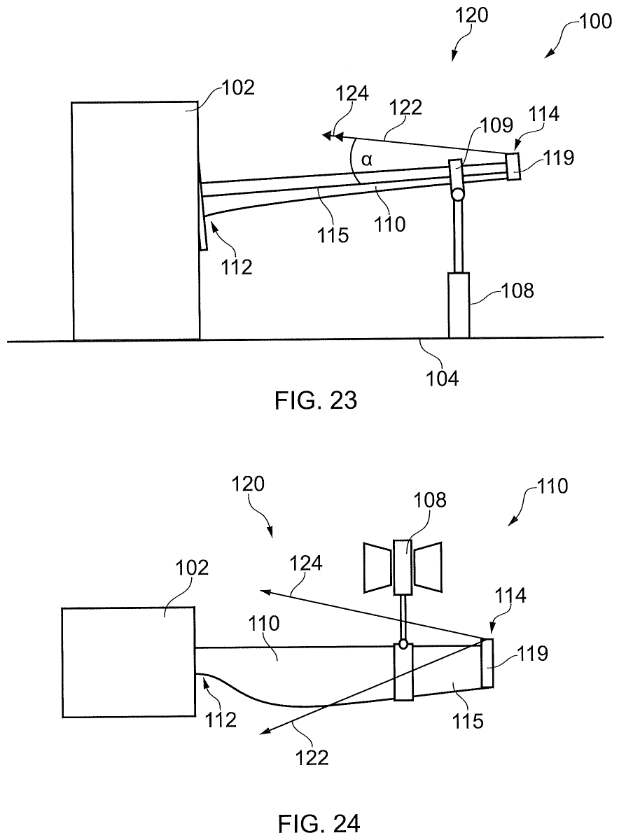

FIGS. 23 to 30 shows various wind turbine blade specimen 110 arranged on testing apparatus 100. In FIG. 23 the testing apparatus 100 may be substantially identical to that described above with reference to FIG. 7a and includes the loads assembly 120. Like reference numerals have been used to denote like parts and will not repeated here for brevity. It will be appreciated that as an alternative to the loads assembly 120, any of the other loads assemblies or first supports or first actuators described above may be alternatively used in the testing apparatus 100.

Unlike the blade specimen 110 in FIG. 7a, the blade specimen in FIG. 23 comprises only a portion of a segmented wind turbine blade, in particular the inboard blade portion 115 and the connector 119 connected to an end surface of the inboard blade portion 115. Notably in the testing setup of FIG. 23, the blade specimen does not have the outboard blade portion 117. The split position of the segmented wind turbine blade at the location of the connector may be located between 10% and 60% of the span of the whole of the segmented wind turbine blade. The connector may be connected to the end surface of the inboard blade portion and to the end surface of the outboard blade portion by fasteners. The use of fasteners to join the blade portions enables testing of only a portion of a segmented wind turbine blade, which may not be possible with a bonded connection between the blade portions.

The connector 119 may be as previously described and may be for connecting the end surface of the inboard blade portion to an end surface of another blade portion to connect the blade portions to each other at a split position of the segmented wind turbine blade having substantially the same structure as an operational segmented wind turbine blade 5 for a wind turbine 1 with blade connecting members 6 such as that shown in FIG. 1. The first support 102 is for holding a first end 112 of the wind turbine blade specimen 110. A first actuator 108 is for applying a first load at a first location on the inboard portion 115 of the wind turbine blade specimen 110 away from the first end.

As the first natural frequencies, flapwise and edgewise, of the inboard portion 115 of the segmented wind turbine blade are significantly higher than for the entire segmented wind turbine blade, the dynamic testing of the inboard blade portion will be much faster than when testing the entire blade with the inboard and outboard blade portions 115, 117 connected by connector 119. This results in a shorter time to market of the production wind turbine blade and faster results of the testing. Further a smaller test hall may be needed both in length and height, due to less blade deflection, which may reduce costs as well.

The wind turbine blade specimen 110 may be orientated at a zero pitch angle with the suction side of the wind turbine blade specimen 110 facing towards the ground 104. The wind turbine blade specimen 110 may be upwardly inclined from the first end 112.

The testing apparatus 100 in FIG. 23 may be for a flatwise test and the first actuator 108 may be a linear actuator, such as a hydraulic actuator. The first actuator 108 is grounded and is configured to apply a point load to the wind turbine blade specimen 110. The wind turbine blade specimen has a neutral axis and the first load to be applied by the first actuator 108 is generally perpendicular to a neutral axis of the wind turbine blade specimen when viewing in the blade chordwise direction. A blade clamp 109 is secured around the wind turbine blade specimen 110 and couples the first actuator 108 to the wind turbine blade specimen 110. The first actuator 108 moves linearly in reciprocation to provide an excitation load to the wind turbine blade specimen via the blade clamp 109 so as to oscillate the wind turbine blade specimen to flap up and down. The blade clamp 109 may be positioned away from the connector 119 and away from the first end 112 of the blade specimen 110.

The first load excites the wind turbine blade specimen 110 to oscillate at a natural frequency of the wind turbine blade specimen. The wind turbine blade specimen 110 flaps up and down towards and away from the ground 104 for a predetermined number of cycles to mimic the sum of dynamic cycles of varying magnitude the production blade may be expected to experience in its lifetime.

As is conventional, a set of strain gauges or other measurement devices (not shown but the same as the devices 130 described above with reference to FIG. 7b but for the inboard blade portion 115 only) on the wind turbine blade specimen 110 may be used to measure the load and/or bending moment and/or deflection of the wind turbine blade specimen 110 during the test.

Cables 122, 124 are pretensioned and carry tensile load such that the load imparted to the wind turbine blade specimen by the first actuator 108 is partially supported by the cables 122, 124 which are coupled to the cable connection point 114 on the connector 119.

The cable connection point 114 is offset from the neutral axis in both the blade chordwise direction and in the blade thickness direction. The cables 122, 124 each extend from the cable connection point 114 at a first angle alpha (α) of approximately 6 degrees with respect to the neutral axis of the wind turbine blade specimen when viewing the wind turbine blade specimen along the blade chordwise direction. The cables extend away from the pressure side of the blade specimen 110, i.e. above the blade specimen in FIG. 23.

Although not shown in FIG. 23, the cable 122 extends from the cable connection point 114 at a second angle beta (β1) and the cable 124 extends from the cable connection point 114 at a second angle beta (β2), each with respect to the neutral axis of the wind turbine blade specimen when viewing the wind turbine blade specimen along the blade thickness direction. The second angles β1 and β2 are similar at around 20 degrees and extend to opposite sides of the blade neutral axis 140 when viewing along the blade thickness direction. For reference, the angles beta may be as the same as shown for the full blade specimen in FIG. 7b.

The excitation of the wind turbine blade specimen 110 may target a bending moment distribution along the spanwise length of the wind turbine blade specimen 110 from first end 112 to the connector 119 (i.e. root to tip of the blade specimen 110 shown in FIG. 23).

The blade connecting members 6 on the operational wind turbine blade 5 (shown in FIG. 1) having substantially the same structure as the wind turbine blade specimen 110 support the loads on the blade. The cables 122, 124 of the test setup are provided to mimic the load relief provided by the blade connecting members 6. The cables 122, 124 are therefore tensioned such that the target bending moment distribution for the wind turbine blade specimen 110 during the test is achieved. The target bending moment distribution accounts for both the first load induced by the first actuator 108 and also the load relief provided by the cables 122, 124 of the load assembly 120. The target bending moment distribution will have a change of slope and a step change in the bending moment at the location of the connector 119 due to the loads relief provided by the blade connecting members 6 of the operational wind turbine blade 5, and due the moment created by the offset between the blade connection point and the blade neutral axis. The same (or as close as possible) change in the bending moment distribution needs to be created in the test setup by the load assembly 120.

The second angles β1 and β2 that the cables 122, 124 make with the blade specimen do not significantly change as the blade specimen 110 flaps up and down in the flatwise fatigue test. The second angles β1 and β2 may be selected to be similar to the angle that the blade connecting members 6 makes with the neutral axis of the operational wind turbine blade 5 but this is not essential and an angular difference between these angles can be accommodated by adjusting the tensile load in the cables 122, 124 to achieve the target bending moment distribution for the blade specimen 110.

However, the first angle alpha (α) of the cables 122, 124 will change as the blade specimen oscillates up and down. The first angle alpha (α) of the cables 122, 124 may be selected to be approximately equal to the angle that the blade connecting members 6 makes with the neutral axis of the operational wind turbine blade 5 at the mean fatigue deflection. The tensile load in the cables 122, 124 which, as mentioned above, extend away from the pressure side 16 of the blade specimen in the flatwise fatigue test, acts against gravity. The loads due to gravity are therefore also taken into account when calculating the blade specimen test setup to achieve the target bending moment distribution for the blade specimen.

The tensile load in the cables 122, 124 may be varied according to the tip deflection position of the blade specimen 110. This variable tensile load is preferable due to the changing first angles alpha that the cables 122, 124 make with the neutral axis of the blade. Mechanisms for providing the cable tension and for providing a variable cable tension are as described above with reference to any of FIGS. 13 to 22 for the full blade specimen test. In the flatwise fatigue test of FIG. 23 the variable cable tension may be selected to provide the target bending moment distribution as the blade specimen oscillates up and down through a range of tip deflection positions. The cable tension required at each tip deflection position to achieve the target bending moment distribution may be based upon expected flatwise static load data, a subset of which may be used in the flatwise (and reverse flatwise) static load testing, the setup of which will now be described.

In a (forward) flatwise static load test (not shown) of the blade specimen 110 used in FIG. 23, comprising only a portion of a segmented wind turbine blade, in particular the inboard blade portion 115 and the connector 119 connected to an end surface of the inboard blade portion 115, the wind turbine blade specimen 110 may be orientated at a zero pitch angle with the suction side of the wind turbine blade specimen 110 facing towards the ground 104. The wind turbine blade specimen 110 may be upwardly inclined from the root 11.

The same set of strain gauges or other measurement devices on the wind turbine blade specimen 110 as described above may be used to measure the load and/or bending moment and/or deflection of the wind turbine blade specimen 110 during the flatwise static test.

Cables 122, 124 may be coupled to the cable connection point 114 on the connector 119 and pretensioned to carry tensile load as described above. The first angle alpha (α) and the second angles beta β1 and β2 may be as previously described.

The loading of the wind turbine blade specimen 110 may target a bending moment distribution along the spanwise length of the wind turbine blade specimen 110 from the first end 112 to the connector 119 (i.e. from root to tip of the blade specimen 110) in the same way as previously described. The cable tension required at the maximum flatwise static test load and corresponding tip deflection position to achieve the target bending moment distribution may be based upon expected flatwise static load data for the wind turbine blade specimen.

In a reverse flatwise static load test (not shown) of the blade specimen 110 used in FIG. 23, comprising only a portion of a segmented wind turbine blade, in particular the inboard blade portion 115 and the connector 119 connected to an end surface of the inboard blade portion 115, the wind turbine blade specimen 110 may be orientated at a 180 degree pitch angle with the pressure side of the wind turbine blade specimen 110 facing towards the ground 104. The wind turbine blade specimen 110 may be upwardly inclined from the first end 112. The angle of inclination of the neutral axis to the ground 104 may be less than for the forward flatwise test setup since the loads and hence the deflection of the connector 119 (at the tip end of the blade specimen 110) to a minimum clearance from the ground 104 are less.

The first actuator may be grounded and configured to apply a distributed load to the wind turbine blade specimen 110 and may have the same setup of a series of grounded winches with cables coupled to respective blade clamps to pull down on the blade specimen 110 towards the ground 104 as described above for the forward flatwise test.

The first load applied at a first location on the wind turbine blade specimen 110 away from the first end 112 deflects the wind turbine blade specimen 110 towards the ground 104 to mimic the maximum reverse flatwise static design load the wind turbine blade specimen 110 is expected to withstand.

The same set of strain gauges or other measurement devices on the wind turbine blade specimen 110 as described above may be used to measure the load and/or bending moment and/or deflection of the wind turbine blade specimen 110 during the reverse flatwise static test.

Cables 122, 124 may be coupled to the cable connection point 114 on the connector 119 and pretensioned to carry tensile load as described above. Since the wind turbine blade specimen is inverted 180 degrees compared to the forward flatwise test setup, the cables 122, 124 extend beneath the wind turbine blade specimen 110. The first angle alpha (α) and the second angles beta β1 and β2 may be as previously described but the angles may be different compared the forward flatwise setup, e.g. if space constraints between the blade specimen 110 and the ground 104 so dictate. Also, the grounded winches couple to the opposite side of the blade clamps as the blade clamps are inverted with the inverted blade specimen 110.

The loading of the wind turbine blade specimen 110 may target a bending moment distribution along the spanwise length of the wind turbine blade specimen 110 from the first end 112 to the connector 119 (i.e. root to tip of the blade specimen 110) in the same way as previously described. The cable tension required at the maximum reverse flatwise static test load and corresponding tip deflection position to achieve the target bending moment distribution may be based upon expected flatwise static load data for the wind turbine blade specimen.

FIG. 24 shows a test apparatus 100 using the same blade specimen 110 comprising the inboard portion 115 of the blade and the connector 119 as illustrated in FIG. 23 but for an edgewise test similar to that described above with reference to FIG. 10a and includes the loads assembly 120. Once again like reference numerals have been used to denote like parts and will not repeated here for brevity. It will be appreciated that as an alternative to the loads assembly 120, any of the other loads assemblies or first supports or first actuators described above may be alternatively used in the testing apparatus 100.

FIG. 24 shows the wind turbine blade specimen 110 arranged on testing apparatus for an edgewise fatigue test. FIG. 24 shows a plan view of the setup.

To reduce the number of setups of the wind turbine blade specimen 110 to complete all of the tests, in the edgewise fatigue load test the wind turbine blade specimen 110 may be orientated at a zero pitch angle with the suction side of the wind turbine blade specimen 110 facing towards the ground 104. The wind turbine blade specimen 110 may be upwardly inclined from the first end 112, although the angle of inclination may be lower than for the flatwise tests described above described with reference to FIG. 23.

The first load may be a point load, such as by using a grounded linear actuator 108 connected to a blade clamp 109. The first load to be applied by the first actuator 108 is generally perpendicular to the neutral axis of the wind turbine blade specimen when viewing in the blade thickness direction. The first actuator 108 may be a hydraulic actuator that moves linearly in reciprocation to provide an excitation load to the wind turbine blade specimen via the blade clamp 109 so as to oscillate the wind turbine blade specimen to move fore and aft generally parallel to the chord of the wind turbine blade specimen 110. The blade clamp 109 may be positioned away from the connector 119 and away from the first end 112.

The first load excites the wind turbine blade specimen 110 to oscillate at a natural frequency of the wind turbine blade specimen to deflect the cantilevered free end of the wind turbine blade specimen fore and aft generally parallel to the chord of the wind turbine blade specimen 110 to mimic the sum of dynamic cycles of varying magnitude the production blade may be expected to experience in its lifetime.

The same set of strain gauges or other measurement devices on the wind turbine blade specimen 110 as described above may be used to measure the load and/or bending moment and/or deflection of the wind turbine blade specimen 110 during the edgewise fatigue test.

Cables 122, 124 may be coupled to the cable connection point 114 on the connector 119 and pretensioned to carry tensile load as described above. The first angle alpha (α) and the second angles beta β1 and β2 may be as previously described. In the edgewise fatigue test with the blade specimen at zero pitch the first angles (α) that the cables 122, 124 make with the blade specimen do not significantly change as the blade specimen 110 moves fore and aft. However, the second angles beta (β1, β2) of the cables 122, 124 will change as the blade specimen oscillates fore and aft. The tensile load in the cables 122, 124 which extend away from the pressure side 16 of the blade specimen in the edgewise fatigue test act against gravity. The loads due to gravity are therefore also taken into account when calculating the blade specimen test setup to achieve the target bending moment distribution for the blade specimen.

The tensile load in the cables 122, 124 may be varied according to the tip deflection position of the blade specimen 110. This variable tensile load is preferable due to the changing second angles beta (β1, β2) that the cables 122, 124 make with the neutral axis of the blade. In the edgewise fatigue test of FIG. 24 the variable cable tension may be selected to provide the target bending moment distribution as the blade specimen oscillates fore and aft through a range of tip deflection positions. The cable tension required at each tip deflection position to achieve the target bending moment distribution may be based upon expected edgewise static load data, a subset of which may be used in the edgewise (and reverse edgewise) static load testing, the setup of which will now be described.

In a (forward) edgewise static load test (not shown) of the blade specimen 110 used in FIG. 24, comprising only a portion of a segmented wind turbine blade, in particular the inboard blade portion 115 and the connector 119 connected to an end surface of the inboard blade portion 115, the wind turbine blade specimen 110 may be orientated at a zero pitch angle with the suction side of the wind turbine blade specimen 110 facing towards the ground 104. The wind turbine blade specimen 110 may be upwardly inclined from the root 11.

The first actuator 108 may be the same as used in the edgewise fatigue test and coupled to the blade by the same blade clamp 109 as described previously with reference to FIG. 24.

The first load may be a point load, such as by using a grounded linear actuator connected to a blade clamp. The first load applied by the first actuator 108 at a first location on the wind turbine blade specimen 110 away from the first end 112 deflects the cantilevered free end of the wind turbine blade specimen aft generally parallel to the chord of the wind turbine blade specimen 110 to mimic the maximum edgewise static design load the wind turbine blade specimen 110 is expected to withstand.

The same set of strain gauges or other measurement devices on the wind turbine blade specimen 110 as described above may be used to measure the load and/or bending moment and/or deflection of the wind turbine blade specimen 110 during the (forward) edgewise static test.

Cables 122, 124 may be coupled to the cable connection point 114 on the connector 119 and pretensioned to carry tensile load as described above. The first angle alpha (α) and the second angles beta β1 and β2 may be as previously described for the edgewise fatigue test. The tensile load in the cables 122, 124 may be varied according to the tip deflection position of the blade specimen 110. This variable tensile load is preferable due to the changing second angles beta 31 and 12 that the cables 122, 124 make with the neutral axis of the blade. In the (forward) edgewise static test the variable cable tension may be selected to provide the target bending moment distribution as the blade specimen deflects aft through a range of tip deflection positions. The cable tension required at each tip deflection position to achieve the target bending moment distribution may be based upon expected edgewise static load data.

The loading of the wind turbine blade specimen 110 may target a bending moment distribution along the spanwise length of the wind turbine blade specimen 110 from the first end 112 to the connector 119 (i.e. root to tip of the blade specimen 110) in the same way as previously described. The cable tension required at the maximum (forward) edgewise static test load and corresponding tip deflection position to achieve the target bending moment distribution may be based upon expected edgewise static load data for the wind turbine blade specimen.

In a reverse edgewise static load test (not shown) of the blade specimen 110 used in FIG. 24, comprising only a portion of a segmented wind turbine blade, in particular the inboard blade portion 115 and the connector 119 connected to an end surface of the inboard blade portion 115, the wind turbine blade specimen 110 may be orientated at a zero pitch angle with the suction side of the wind turbine blade specimen 110 facing towards the ground 104. The wind turbine blade specimen 110 may be upwardly inclined from the first end 112.

The first load may be a point load, such as by using a grounded linear actuator connected to a blade clamp. The first actuator 108 may be the same as used in the edgewise fatigue test and coupled to the blade by the same blade clamp 109 as described previously with reference to FIG. 24.

The first load applied by the first actuator 108 at a first location on the wind turbine blade specimen 110 away from the first end 112 deflects the cantilevered free end of the wind turbine blade specimen forward generally parallel to the chord of the wind turbine blade specimen 110 to mimic the maximum reverse edgewise static design load the wind turbine blade specimen 110 is expected to withstand.

The same set of strain gauges or other measurement devices on the wind turbine blade specimen 110 as described above may be used to measure the load and/or bending moment and/or deflection of the wind turbine blade specimen 110 during the reverse edgewise static test.

Cables 122, 124 may be coupled to the cable connection point 114 on the connector 119 and pretensioned to carry tensile load as described above. The first angle alpha (α) and the second angles beta β1 and β2 may be as previously described for the edgewise fatigue test. The tensile load in the cables 122, 124 may be varied according to the tip deflection position of the blade specimen 110. This variable tensile load is preferable due to the changing second angles beta β1 and β2 that the cables 122, 124 make with the neutral axis of the blade. In the reverse edgewise static test the variable cable tension may be selected to provide the target bending moment distribution as the blade specimen deflects forward through a range of tip deflection positions. The cable tension required at each tip deflection position to achieve the target bending moment distribution may be based upon edgewise static load predicted data.

The loading of the wind turbine blade specimen 110 may target a bending moment distribution along the spanwise length of the wind turbine blade specimen 110 from the first end 112 to the connector 119 (i.e. root to tip of the blade specimen 110) in the same way as previously described. The cable tension required at the maximum reverse edgewise static test load and corresponding tip deflection position to achieve the target bending moment distribution may be based upon expected edgewise static load data for the wind turbine blade specimen.

The load assembly 120 applies a tension in the cables 122, 124 as mentioned above. It will be appreciated that as an alternative to the loads assembly 120, any of the other loads assemblies or first supports described above may be alternatively used in the testing apparatus 100.

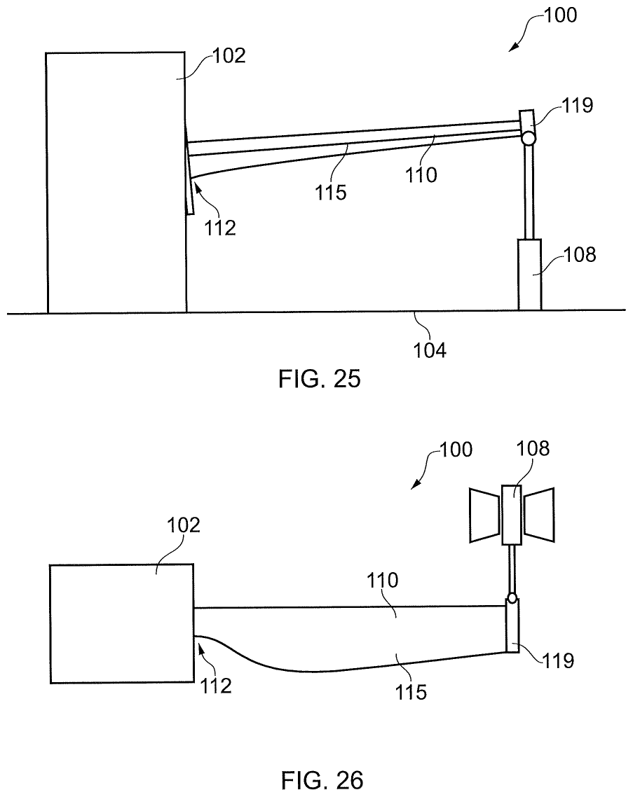

FIGS. 25 and 26 show modified versions of the test apparatus 100 described above with reference to FIGS. 23 and 24 in which the blade specimen 110 comprises only a portion of a segmented wind turbine blade, in particular the inboard blade portion 115 and the connector 119 connected to an end surface of the inboard blade portion 115. Notably in the testing setup of FIGS. 25 and 26, the blade specimen does not have the outboard blade portion 117. Further notably the blade specimen 110 in FIGS. 25 and 26 is for testing a wind turbine blade that will have no connecting members 6 connected between the blades of the rotor of the wind turbine, such that the wind turbine rotor comprises simply cantilevered blades extending radially from the hub 4. Therefore, the testing apparatus 100 in FIG. 25 may be the same as that described above with reference to FIG. 23 but lacking the loads assembly 120, and so has no cables coupled to the connector 119.

The split position of the segmented wind turbine blade at the location of the connector may be located between 10% and 60% of the span of the whole of the segmented wind turbine blade. The connector may be connected to the end surface of the inboard blade portion and to the end surface of the outboard blade portion by fasteners.

The connector 119 may be as previously described and may be for connecting the end surface of the inboard blade portion to an end surface of another blade portion to connect the blade portions to each other at a split position of the segmented wind turbine blade having substantially the same structure as an operational or production segmented wind turbine blade. The first support 102 is for holding a first end 112 of the wind turbine blade specimen 110.

A first actuator 108 is for applying a first load at a first location on the inboard portion 115 of the wind turbine blade specimen 110 away from the first end. In the example illustrated in FIGS. 25 and 26 the first actuator 108 may be coupled to the blade specimen 110 at the connector 119. Alternatively one or more blade clamps may be provided along the length of the blade specimen 110 for coupling one or more actuators to the blade specimen for testing the blade specimen, similar to the previously described examples.

Having the connector attached to the end surface at the tip end of the inboard blade portion of the segmented wind turbine blade may be advantageous for one or more of the following reasons. The connector has a mass, which may be a significant mass, and this may alter the natural frequency of the blade specimen and may also reduce or alleviate the need to add additional masses to the blade specimen for any other reason for the testing. Furthermore, the connector may provide a convenient location for attaching the first actuator so that the first actuator does not require additional attachment devices, such as a blade clamp, for connection of the blade specimen. Yet further, the presence of the connector may be used to measure the connection, e.g. bolting, loads between the connector and the tip end of the inboard blade portion during the test so that this connection does not need to be tested separately.

The first load to be applied by the first actuator may be a point load. The first load to be applied by the first actuator may be a distributed load. The first load to be applied by the first actuator may be a static load for subjecting the wind turbine blade specimen to a static load test. The first load to be applied by the first actuator may be an excitation load for subjecting the wind turbine blade specimen to a fatigue load test.

The first load to be applied by the first actuator 108 may be generally perpendicular to a neutral axis of the wind turbine blade specimen when viewing in the blade chordwise direction, as shown in FIG. 25. Alternatively, the first load to be applied by the first actuator 108 may be generally perpendicular to a neutral axis of the wind turbine blade specimen when viewing in the blade thickness direction, as shown in FIG. 26. The first actuator may apply the first load to achieve a pre-determined bending moment distribution along the wind turbine blade specimen during a static or fatigue test of the wind turbine blade specimen. The first actuator may apply the first load to excite the wind turbine blade specimen at a natural frequency of the wind turbine blade specimen to generate the pre-determined bending moment distribution.

The static and fatigue tests may be carried out with the wind turbine blade specimen in a zero degree or 180 degree pitch orientation with respect to the horizontal. The first support may be adjustable to orient the first end of the wind turbine blade specimen at one of a plurality of angles with respect to the horizontal.

For testing the wind turbine blade specimen 110 in FIG. 25, the first end 112 of the wind turbine blade specimen 110 is held by the first support 102, and the first actuator 108 is used to apply a first load at a first location on the wind turbine blade specimen away from the first end 112, and one or more parameters of the wind turbine blade specimen are measured while the first load is applied.

The wind turbine blade specimen 110 may undergo one or more of a flatwise static load test, a reverse flatwise static load test, an edgewise static load test, a reverse edgewise static load test, a flatwise fatigue load test, and an edgewise fatigue load test, amongst others, the same or similar to those tests described above. A set of strain gauges on the wind turbine blade specimen 110 may be used to measure strains or bending moments at various points on the wind turbine blade specimen 110 during each of the tests.

The first load applied to the inboard blade portion may be applied up to a first load level due to expected loads from a first outboard blade portion intended to be coupled with the inboard blade portion 115. The testing regime may further comprise repeating the testing of the same inboard blade portion specimen by applying the first load to the inboard blade portion from the first load level up to a second load level due to expected loads from a second outboard blade portion intended to be coupled with the inboard blade portion, where the second outboard blade portion is different than the first outboard blade portion and imparts higher expected loads to the inboard blade portion than did the first outboard blade portion.

This may enable reduced testing time of the inboard blade portion for testing a family of blades of different spanwise lengths where the inboard blade portion may be common amongst the family of blades and to be used with one of a plurality of outboard blade portions of different lengths.

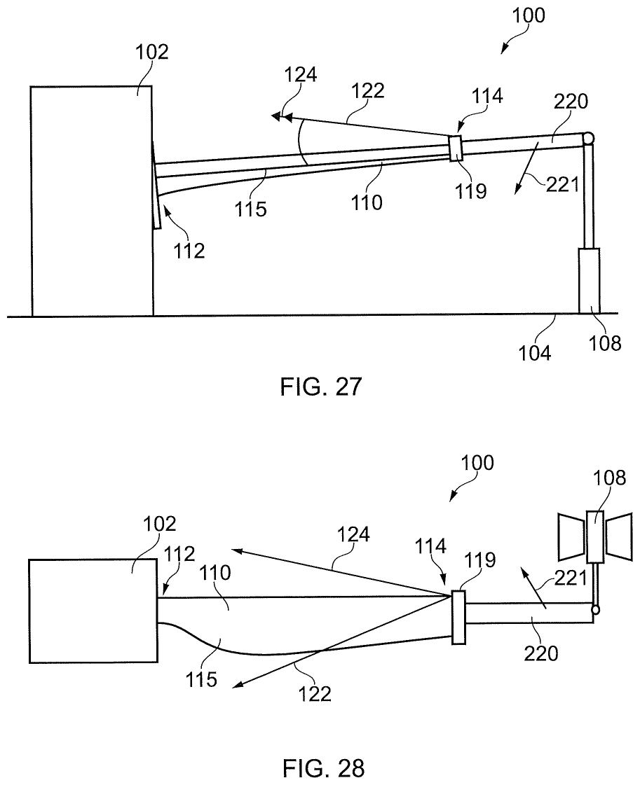

FIGS. 27 and 28 show modified versions of the test apparatus 100 described above with reference to FIGS. 23 and 24 in which the blade specimen 110 comprises a portion of a segmented wind turbine blade, in particular the inboard blade portion 115 and the connector 119 connected to an end surface of the inboard blade portion 115, and also an extension member 220 connected to the connector 119 and extending away from the inboard blade portion 115.

Therefore, the testing apparatus 100 in FIGS. 27 and 28 may be substantially the same as that described above with reference to FIGS. 23 and 24 but in which the loads assembly may be modified to apply a force, e.g. via a cable 221, to the extension member 220 to impart a moment at the connector 119. This force applied at the extension member may be in addition to the forces applied by cable 122 and or 124 at the connection point on the connector 119, or may be instead of the forces applied by the cables 122, 124 in which case those cables 122, 124 may be omitted. The force applied via cable 221 or otherwise may be applied at the free (tip) end of the extension member 220 or at any location along the spanwise length of the extension member 220. The modified loads assembly for imparting the moment at the connector 119 via the extension member may use a hydraulic actuator (not shown) for applying the load to the cable 221 or by alternative methods.

The extension member 220 may be a steel beam. The extension member 220 may be connected to the inboard blade portion 115 at the connector 119 by fasteners. The extension member may be around 5 m to 15 m long, e.g. around 10 m.

The first actuator 108 may apply the first load at a location on the inboard blade portion 115 or at a location on the extension member 220, e. g as shown in FIGS. 27 and 28.

The extension member 220 may also enable greater freedom for positioning the first actuator 108 away from the first end 112 even on the shorter length of the blade specimen for testing only the inboard portion 115 of a blade and not also the outboard portion of a segmented blade. For example, the same positioning of the first actuator 108 as in FIGS. 7a, 7b, 8a, 8b, 9a, 9b may be used for testing the partial blade having only the inboard blade portion 115. The addition of the extension member 220 provides greater bending moment on the inboard portion 115 being tested and/or a smaller first actuator to be used.

In all other respects the testing apparatus 100 and the testing methods may be the same as previously described.

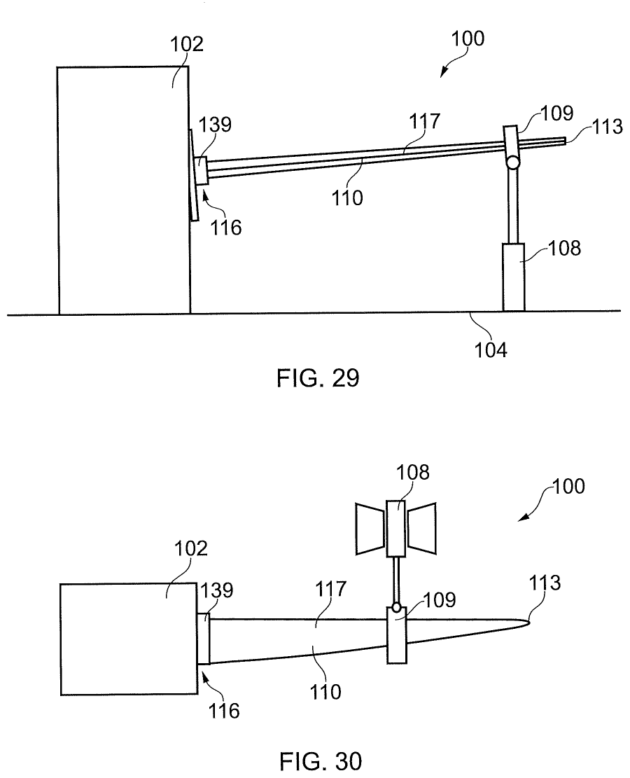

FIGS. 29 and 30 show modified versions of the test apparatus 100 described above with reference to FIGS. 23 and 24 in which the blade specimen 110 comprises a portion of a segmented wind turbine blade, in particular the outboard blade portion 117 and a mounting connector 139 connected to an end surface of the inboard blade portion 115. The outboard blade portion may have a root end 116 and a tip end 113, and the mounting connector 139 connects the end surface at the root end 116 to the first support 102. The mounting connector is at the first end 112 of the blade specimen 110.

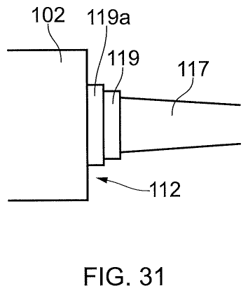

The mounting connector 139 may be, or may include, the connector 119 for the operational segmented wind turbine blade. The mounting connector 139 may therefore have the same structure as the connector 119 to be used on the operational wind turbine blade. Alternatively, the mounting connector 139 may include the connector 119 and may further include an adaptor 119a for coupling the connector 119 to the first support 102, for example as shown in FIG. 31. The adaptor may be separate from the connector or may be integrally formed with the connector. Further alternatively, the mounting connector may be a bespoke part having a first face for connecting to the first support and a second face for connecting to the end surface at the root end of the outboard blade portion.

Therefore, the testing apparatus 100 in FIGS. 29 and 30 may be substantially the same as that described above with reference to FIGS. 23 and 24 but in which the wind turbine blade specimen 110 comprises the outboard blade portion 117.

The split position of the segmented wind turbine blade at the location of the connector may be located between 10% and 60% of the span of the whole of the segmented wind turbine blade. The connector may be connected to the end surface of the inboard blade portion and to the end surface of the outboard blade portion by fasteners.

A first actuator 108 is for applying a first load at a first location on the outboard portion 117 of the wind turbine blade specimen 110 away from the first end 112. In the example illustrated in FIGS. 29 and 30 one or more blade clamps 109 may be provided along the length of the blade specimen 110 for coupling one or more first actuators 108 to the blade specimen for testing the blade specimen, similar to the previously described examples.

The first load to be applied by the first actuator may be a point load. The first load to be applied by the first actuator may be a distributed load. The first load to be applied by the first actuator may be a static load for subjecting the wind turbine blade specimen to a static load test. The first load to be applied by the first actuator may be an excitation load for subjecting the wind turbine blade specimen to a fatigue load test.

The first load to be applied by the first actuator 108 may be generally perpendicular to a neutral axis of the wind turbine blade specimen when viewing in the blade chordwise direction, as shown in FIG. 29. Alternatively, the first load to be applied by the first actuator 108 may be generally perpendicular to a neutral axis of the wind turbine blade specimen when viewing in the blade thickness direction, as shown in FIG. 30. The first actuator may apply the first load to achieve a pre-determined bending moment distribution along the wind turbine blade specimen during a static or fatigue test of the wind turbine blade specimen. The first actuator may apply the first load to excite the wind turbine blade specimen at a natural frequency of the wind turbine blade specimen to generate the pre-determined bending moment distribution.

The static and fatigue tests may be carried out with the wind turbine blade specimen in a zero degree or 180 degree pitch orientation with respect to the horizontal. The first support may be adjustable to orient the first end of the wind turbine blade specimen at one of a plurality of angles with respect to the horizontal.

For testing the wind turbine blade specimen 110 in FIG. 29, the first end 112 of the wind turbine blade specimen 110 is held by the first support 102, and the first actuator 108 is used to apply a first load at a first location on the wind turbine blade specimen away from the first end 112, and one or more parameters of the wind turbine blade specimen are measured while the first load is applied.

The wind turbine blade specimen 110 may undergo one or more of a flatwise static load test, a reverse flatwise static load test, an edgewise static load test, a reverse edgewise static load test, a flatwise fatigue load test, and an edgewise fatigue load test, amongst others, the same or similar to those tests described above. A set of strain gauges on the wind turbine blade specimen 110 may be used to measure strains or bending moments at various points on the wind turbine blade specimen 110 during each of the tests.

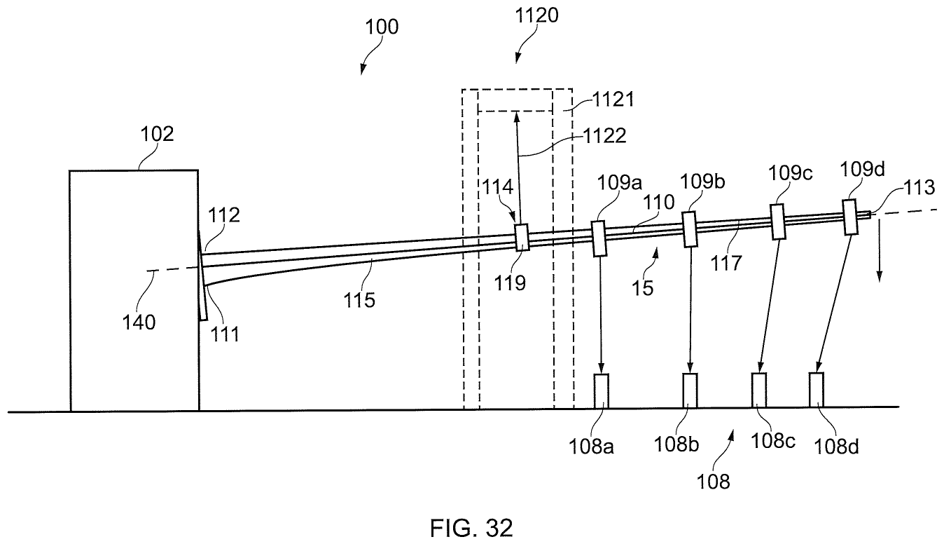

FIG. 32 shows a wind turbine blade specimen 110 arranged on testing apparatus 100 for a (forward) flatwise static test. In this example, the wind turbine blade specimen 110 and the testing apparatus are almost identical to that shown in FIG. 8a and like reference numerals denote like parts and will not be described again for brevity. The only difference is the loads assembly 1120 which comprises a grounded frame 1121 and at least one cable 1122 connected to the cable connection point 114 on the connector 119.

Cable 1122 is pretensioned and carry tensile load such that the load imparted to the wind turbine blade specimen by the first actuator 108 is partially supported by the cable 1122 which is coupled to the grounded frame 1121 to react the loads in the cable 1122.

The target bending moment distributions to be used in the blade specimen testing derived are achieved by the first load applied by the first actuator 108 in combination with the loads relief provided by the loads assembly 1120.

A notable difference between the cable 1122 in FIG. 32 and the setup shown in FIG. 8a is that a single cable is preferably employed here and that the cable extends substantially perpendicular to the blade neutral axis 140. This does not represent the loading of the operational wind turbine blade 5 as closely as does the setup of FIG. 8a but it is simpler and may have certain advantages. The cable 1122 of the loads assembly 1122 behaves as a simple ‘counter pull’ to mimic or approximate the reduction in the root bending moment of the target bending moment distribution without the step in the bending moment distribution that the operational wind turbine blade would see due to the angles that the operational cables make with the blade.

FIG. 34 shows a sample bending moment distribution achievable with the loads assembly 1120 which shows the bending moment distribution (solid line) and the change of slope in this distribution inboard of the cable connection point 114. As can be seen, the slope is reduced radially inboard of the cable connection point 114 due to the loads relief provided by the cable 1122 as compared with the slope radially outboard of the cable connection point 114. The broken line shows a sample bending moment distribution without the loads relief, so as to show the root bending moment reduction. There is no step in the bending moment distribution of FIG. 34, unlike the bending moment distribution of FIG. 14, since the cable 1122 is not offset from the neutral axis of the blade and so does not create the additional moment at that point in the manner previously described.

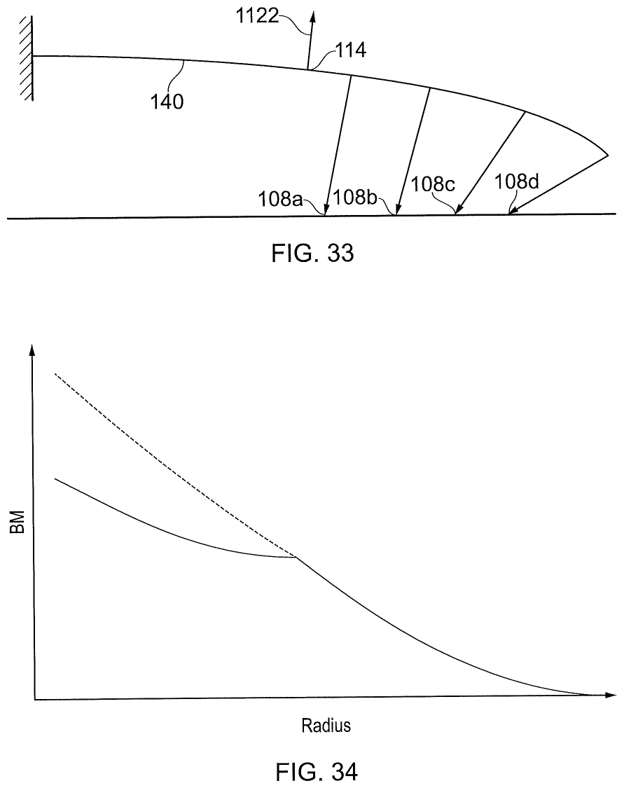

Although FIGS. 32 to 34 are described in relation to a forward flatwise test it will be appreciated that the above described adaptions for the reverse flatwise and fatigue testing can be made whilst using the loads assembly 1120.

The load in the cable 1122 may be constant as the blade deflects under the first load of the first actuator 108 or may be displacement varying, using any of the mechanisms previously described.

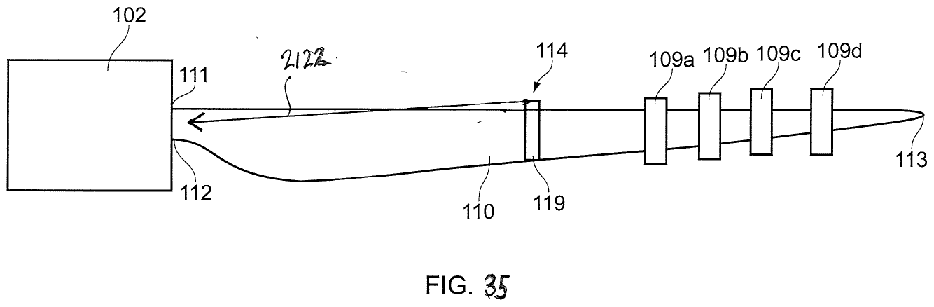

In a further alternative arrangement as illustrated in FIG. 35 in which like reference numerals are used to denote like features, a single cable denoted 2122 is likewise employed connected to cable connection point 114 but this is arranged to be passed back to the block 102 in similar manner to earlier described embodiments. This makes a similar first angle alpha (α) being a small acute angle for example 6 degrees when viewed in the chordwise direction to the blade neutral axis as the embodiment of FIG. 8. When viewed in the thickness direction the cable 2122 extends in a direction which substantially bisects the angle between the cables of FIG. 8b. This arrangement has the advantage that only a single cable is being employed, for benefits of simplicity compared to the arrangement of FIG. 7 but which carries a more accurate representation of load relief as experienced in the actual blade as the first angle may be an accurate representation of the angle employed in the actual blade specimen being tested. FIG. 35 shows an arrangement providing a static test with blade clamps 109a to 109d. For the purposes of a fatigue test a single blade clamp 109 is provided to which reciprocating actuator 108 is attached as shown in FIG. 7.

Although the invention has been described above with reference to one or more preferred embodiments, it will be appreciated that various changes or modifications may be made without departing from the scope of the invention as defined in the appended claims.

1.-62. (canceled)

63. An apparatus for testing a wind turbine blade specimen having a cable connection point, the apparatus comprising:
a first support for holding a first end of the wind turbine blade specimen,
a first actuator for applying a first load at a first location on the wind turbine blade specimen away from the first end,
a load assembly including at least one cable for coupling to the cable connection point at a second location on the wind turbine blade specimen away from the first end,
wherein the at least one cable is configured to carry a tensile load such that the load imparted to the wind turbine blade specimen by the first actuator is partially supported by the at least one cable.

64. The apparatus according to claim 63, wherein the load assembly includes a plurality of cables for coupling to the same cable connection point on the wind turbine blade specimen.

65. The apparatus according to claim 63, further comprising the wind turbine blade specimen having the cable connection point, wherein the first support holds the first end of the wind turbine blade specimen, and the at least one cable is coupled to the cable connection point at a second location on the wind turbine blade specimen away from the first end.

66. The apparatus according to claim 65, wherein the wind turbine blade specimen is an entire wind turbine blade and has a root, a tip, and a span extending form the root to the tip, wherein the span substantially corresponds to span of an operational wind turbine blade having substantially the same structure as the wind turbine blade specimen.

67. The apparatus according to claim 66, wherein the wind turbine blade specimen is a segmented wind turbine blade having an inboard blade portion and an outboard blade portion connected to each other at a split position, wherein the inboard blade portion and outboard blade portion are connected by a connection joint, and wherein the connection joint includes a connector connected to an end surface of the inboard blade portion and to an end surface of the outboard blade portion.

68. The apparatus according to claim 65, wherein the wind turbine blade specimen is a portion of a segmented wind turbine blade having substantially the same structure as an operational segmented wind turbine blade.

69. The apparatus according to claim 65, wherein the wind turbine blade specimen comprises an inboard blade portion of a segmented wind turbine blade and a connector connected to an end surface of the inboard blade portion, and wherein the cable connection point is on the connector, and wherein the connector is for connecting the end surface of the inboard blade portion to an end surface of an outboard blade portion to connect the inboard blade portion and the outboard blade portion to each other at a split position of the segmented wind turbine blade having substantially the same structure as an operational segmented wind turbine blade.

70. The apparatus according to claim 69, wherein the wind turbine blade specimen further comprises an extension member connected to the connector and extending away from the inboard blade portion, and wherein the cable connection point is on the extension member.

71. The apparatus according to claim 65, wherein the cable connection point is located a distance from a neutral axis of the wind turbine blade specimen.

72. The apparatus according to claim 65, wherein the at least one cable extends from the cable connection point at an angle with respect to a neutral axis of the wind turbine blade specimen, wherein the angle is an acute angle less than 45 degrees.

73. A method of testing a wind turbine blade specimen comprising:
providing a wind turbine blade specimen having a cable connection point;
supporting a first end of the wind turbine blade specimen;
connecting at least one cable to the cable connection point at a second location on the wind turbine blade specimen away from the first end;
tensioning the at least one cable;
using a first actuator to apply a first load at a first location on the wind turbine blade specimen away from the first end;
using the at least one cable to carry a tensile load such that the load imparted to the wind turbine blade specimen by the first actuator is partially supported by the at least one cable; and
measuring one or more parameters of the wind turbine blade specimen.

74. The method according to claim 73, wherein the wind turbine blade specimen is an entire wind turbine blade and has a root, a tip, and a span extending form the root to the tip, wherein the span substantially corresponds to span of an operational wind turbine blade having substantially the same structure as the wind turbine blade specimen.

75. The method according to claim 74, wherein the wind turbine blade specimen is a segmented wind turbine blade having an inboard blade portion and an outboard blade portion connected to each other at a split position, wherein the inboard blade portion and outboard blade portion are connected by a connection joint, and wherein the connection joint includes a connector connected to an end surface of the inboard blade portion and to an end surface of the outboard blade portion, and wherein the cable connection point is on the connector.

76. The method according to claim 73, wherein the wind turbine blade specimen is a portion of a segmented wind turbine blade having substantially the same structure as an operational segmented wind turbine blade.

77. The method according to claim 73, wherein the wind turbine blade specimen comprises an inboard blade portion of a segmented wind turbine blade and a connector connected to an end surface of the inboard blade portion, and wherein the cable connection point is on the connector, wherein the connector is for connecting the end surface of the inboard blade portion to an end surface of an outboard blade portion to connect the inboard blade portion and the outboard blade portion to each other at a split position of the segmented wind turbine blade having substantially the same structure as an operational segmented wind turbine blade.

78. The method according to claim 77, wherein the wind turbine blade specimen further comprises an extension member connected to the connector and extending away from the inboard blade portion, and wherein the cable connection point is on the extension member.

79. The method according to claim 73, wherein the first actuator applies the first load to achieve a pre-determined bending moment distribution along the wind turbine blade specimen during a static or fatigue test of the wind turbine blade specimen.

80. The method according to claim 79, wherein the at least one cable is tensioned to achieve a pre-determined step change and/or change of slope in the bending moment distribution along the wind turbine blade specimen at the location of the cable connection point during the static or fatigue test of the wind turbine blade specimen.

81. The method according to claim 79, wherein the first actuator applies the first load to excite the wind turbine blade specimen at a natural frequency of the wind turbine blade specimen to generate the pre-determined bending moment distribution.

82. The method according to claim 73, wherein the first load applied by the first actuator is a pull down load during both a flatwise static test and a reverse flatwise static test of the wind turbine blade specimen, and wherein the at least one cable extends away from the cable connection point above the wind turbine blade specimen in the flatwise test, and wherein the at least one cable extends away from the cable connection point below the wind turbine blade specimen in the reverse flatwise test.
